(19) United States
(12) Patent Application Publication
(10) Pub. No.: US 2026/0019162 A1
(43) Pub. Date: Jan. 15, 2026

(54) CONTROL DEVICE, OPTICAL RECEIVER, AND OPTICAL TRANSMITTER

(71) Applicant: FUJITSU OPTICAL COMPONENTS LIMITED, Kawasaki-shi (JP)

(72) Inventors: Shigeru Moribayashi, Kawasaki (JP); Masaki SUGIYAMA, Kawasaki (JP); Shigeki Nishida, Kawasaki (JP); Yusuke KURIHARA, Kawasaki (JP)

(73) Assignee: FUJITSU OPTICAL COMPONENTS LIMITED, Kawasaki-shi (JP)

(21) Appl. No.: 19/056,342

(22) Filed: Feb. 18, 2025

(30) Foreign Application Priority Data
Jul. 10, 2024 (JP) 2024-111243

(51) Int. Cl. H04B 10/69

(52) U.S. Cl. CPC H04B 10/6911

(57) ABSTRACT

A control device has an attenuator, a monitor that measures a peripheral temperature around the attenuator, and a controller. The controller stores a first function approximating a relation between amounts of attenuation and driving current values at a standard temperature, and a second function for calculating a temperature correction factor that corrects a driving current value between the peripheral temperature and the standard temperature. The controller calculates, by the first function, a driving current value at the standard temperature, and calculates, by the second function, a temperature correction factor. Based on the driving current value at the standard temperature and calculated by the first function and the temperature correction factor calculated by the second function, the controller calculates a driving current value for obtaining the set amount of attenuation at the peripheral temperature. The controller controls driving of the attenuator based on the driving current value calculated.

### CROSS-REFERENCE TO RELATED APPLICATION

This application is based upon and claims the benefit of priority of the prior Japanese Patent Application No. 2024-111243, filed on Jul. 10, 2024, the entire contents of which are incorporated herein by reference.

### FIELD

The embodiments discussed herein are related to a control device, an optical receiver, and an optical transmitter.

### BACKGROUND

FIG. 21 is a block diagram illustrating an example of a conventional control device 100. The control device 100 has a variable optical attenuator (VOA) 101, an optical monitor 102, and a control unit 103. The VOA 101 is a variable attenuator that attenuates input light. The optical monitor 102 detects signal intensity of output light from the VOA 101. The control unit 103 adjusts an amount of attenuation by the VOA 101 on the basis of a detection result from the optical monitor 102.

The optical monitor 102 is not capable of detecting accurate signal intensity because the signal intensity detected by the optical monitor 102 has high temperature dependence and fluctuates correspondingly to temperature, and the amount of attenuation by the VOA 101 is thus unable to be adjusted accurately.

Therefore, the control unit 103 in the conventional control device 100 corrects a driving current value for obtaining a set amount of attenuation by the VOA 101, by using sensitivity characteristics corresponding to the ambient temperature.
Patent Literature 1: Japanese Laid-open Patent Publication No. 2019-009488
Patent Literature 2: U.S. Patent Application Publication No. 2011/0206386
Patent Literature 3: Japanese Laid-open Patent Publication No. 2019-134277
Patent Literature 4: Japanese Laid-open Patent Publication No. 2006-275705
Patent Literature 5: Japanese Laid-open Patent Publication No. 2007-274258
Patent Literature 6: U.S. Patent Application Publication No. 2007/0230959

However, in the conventional control device 100, data for preparing the sensitivity characteristics are needed in correcting the driving current value for obtaining the set amount of attenuation by the VOA 101 by use of the sensitivity characteristics corresponding to the ambient temperature. What is more, the sensitivity characteristics corresponding to the ambient temperature need to be prepared in the control device 100 and the amount of data on the sensitivity characteristics need to be increased for the correction precision to be increased. In addition, complicated arithmetic processing is needed in calculation of the driving current value for the VOA 101 using the sensitivity characteristics prepared.

What is more, performing feedback (FB) control for a different purpose, for example, FB control of adjusting the output amplitude of an optical receiver while executing FB control for adjusting the amount of attenuation by the VOA 101 on the basis of the result of the monitoring by the optical monitor 102 in the control device 100 is multiple loop control, which is difficult. Therefore, the processing load for accurately calculating the driving current value for obtaining the set amount of attenuation in the control device 100 is large.

### SUMMARY

According to an aspect of an embodiment, a control device includes a variable attenuator that attenuates input light, a temperature monitor that measures a peripheral temperature around the variable attenuator, and a controller that controls the variable attenuator. The controller includes processing circuitry. The processing circuitry is configured to store a first function approximating a relation between amounts of attenuation and driving current values for the variable attenuator at a standard temperature, and a second function for calculating a temperature correction factor that corrects a driving current value between the peripheral temperature and the standard temperature. The processing circuitry is configured to calculate, by substituting a set amount of attenuation into the first function, a driving current value at the standard temperature, calculate, by substituting a current peripheral temperature into the second function, a temperature correction factor at the peripheral temperature, and calculate, based on the driving current value at the standard temperature and calculated by the first function and the temperature correction factor at the peripheral temperature and calculated by the second function, a driving current value for obtaining the set amount of attenuation at the peripheral temperature. The processing circuitry is configured to control driving of the variable attenuator based on the driving current value calculated by the calculating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a control device according to a first embodiment;

FIG. 2 is a diagram illustrating an example of quadratic curves each approximating a relation between amounts of attenuation and driving current values for a reference temperature;

FIG. 3 is a diagram illustrating a graph having values plotted therein, the values resulting from normalization of the driving current values for the respective reference temperatures with a standard temperature;

FIG. 4 is a flowchart illustrating an example of processing operation by a control unit, the processing operation being related to a first setting process;

FIG. 5 is a flowchart illustrating an example of processing operation by the control unit, the processing operation being related to a first calculation process;

FIG. 6 is a block diagram illustrating an example of a control device according to a second embodiment;

FIG. 7 is a diagram illustrating an example of quadratic curves each approximating a relation between amounts of attenuation and driving current values for a reference wavelength;

FIG. 8 is a diagram illustrating a graph having values plotted therein, the values resulting from normalization of the driving current values for the respective reference wavelengths with a standard wavelength;

FIG. 9 is a flowchart illustrating an example of processing operation by a control unit, the processing operation being related to a second setting process;

FIG. 10 is a flowchart illustrating an example of processing operation by the control unit, the processing operation being related to a second calculation process;

FIG. 11 is a block diagram illustrating an example of a control device according to a third embodiment;

FIG. 12 is a flowchart illustrating an example of processing operation by a control unit, the processing operation being related to a third calculation process;

FIG. 13 is a diagram illustrating an example of combinations of measurement conditions for obtainment of attenuation amount characteristics at the control device according to the third embodiment;

FIG. 14 is a block diagram illustrating an example of a control device according to a fourth embodiment;

FIG. 15 is a flowchart illustrating an example of processing operation by a control unit, the processing operation being related to a third setting process;

FIG. 16 is a flowchart illustrating an example of processing operation by the control unit, the processing operation being related to a fourth calculation process;

FIG. 17 is a block diagram illustrating an example of a control device according to a fifth embodiment;

FIG. 18 is a flowchart illustrating an example of processing operation by a user device, the processing operation being related to a user calculation process;

FIG. 19 is a flowchart illustrating an example of processing operation by a control unit, the processing operation being related to a fifth calculation process;

FIG. 20 is a diagram illustrating an example of an optical transceiver according to an embodiment; and

FIG. 21 is a block diagram illustrating an example of a conventional control device.

### DESCRIPTION OF EMBODIMENTS

Preferred embodiments of the present invention will be explained with reference to accompanying drawings. The present invention is not to be limited by these embodiments.

### (a) First Embodiment

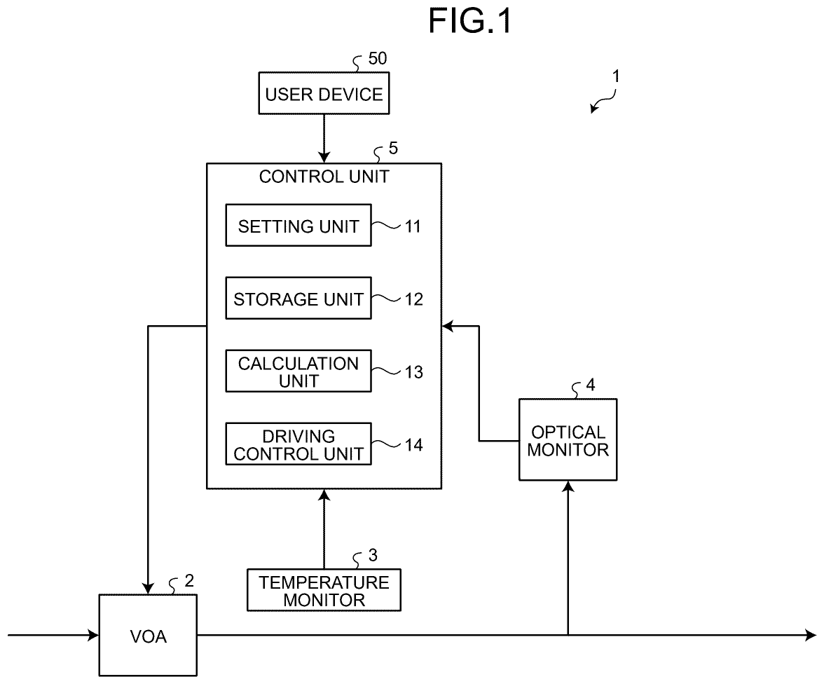

FIG. 1 is a block diagram illustrating an example of a control device 1 according to a first embodiment. The control device 1 is a module having a variable optical attenuator (VOA) 2, a temperature monitor 3, an optical monitor 4, and a control unit 5. The VOA 2 is, for example, an electroabsorption variable attenuator that variably attenuates input light according to driving current. The VOA 2 includes, for example, an IC of silicon photonics. The temperature monitor 3 is a sensor that measures a peripheral temperature around the VOA 2. The optical monitor 4 measures an amount of attenuation by the VOA 2 from output power, for example, signal intensity, of the VOA 2. An user device 50 sets various kinds of information on the control device 1 according to setting operation, for example.

The control unit 5 controls the VOA 2. The control unit 5 controls the VOA 2 by using attenuation amount characteristics that are based on a standard temperature and are obtained beforehand. On the basis of the attenuation amount characteristics based on the standard temperature, a set temperature for the VOA 2, and a set amount of attenuation for the VOA 2, the control unit 5 calculates a driving current value for obtaining the set amount of attenuation at the set temperature. The control unit 5 then supplies driving current corresponding to the calculated driving current value, to the VOA 2. The control unit 5 obtains the set temperature from the temperature monitor 3 and obtains the set amount of attenuation from the user device 50.

The control unit 5 has a setting unit 11, a storage unit 12, a calculation unit 13, and a driving control unit 14. The setting unit 11 calculates a first function and a second function that are some of the attenuation amount characteristics, and stores the calculated first function and second function, into the storage unit 12. The first function is an equation of a quadratic curve approximating a relation between amounts of attenuation by the VOA 2 and driving current values at the standard temperature described later. The second function is an equation for calculating a temperature correction factor that corrects a driving current value between the set temperature for the VOA 2 and the standard temperature.

By substituting the set amount of attenuation into the first function, the calculation unit 13 calculates a driving current value at the standard temperature. By substituting the current peripheral temperature as the set temperature into the second function, the calculation unit 13 calculates a temperature correction factor for the set temperature. Furthermore, on the basis of the driving current value at the standard temperature and calculated by the first function and the temperature correction factor at the set temperature and calculated by the second function, the calculation unit 13 calculates a driving current value for obtaining the set amount of attenuation at the set temperature and sets the calculated driving current value on the driving control unit 14. The driving control unit 14 supplies driving current corresponding to the set driving current value, to the VOA 2.

Instead of being used for FB control, the optical monitor 4 is used to measure amounts of attenuation by the VOA 2, the amounts needed for calculation of the attenuation amount characteristics.

Operation of the control unit 5 for setting the first function and the second function will be described next. The optical monitor 4 successively measures amounts of attenuation by the VOA 2 under predetermined driving current conditions for each of at least three reference temperatures T1, T2, and T3 beforehand. The predetermined driving current conditions are conditions where input light has a wavelength at a standard wavelength of λ2 nm and the VOA 2 is driven at, for example, four driving current values of 0 mA, I1 mA, I2 mA, and I3 mA. The number of the driving current values is not limited to four and may be modified as appropriate to be two or more. Each reference temperature is obtained from the temperature monitor 3. If the temperature difference between the temperature monitor 3 and the VOA 2 is always constant, the temperature state of the VOA 2 is not easily affected by the form of heat radiation by the control unit 5, for example, and more accurate temperature correction is enabled. Therefore, the temperature monitor 3 is desirably near the VOA 2.

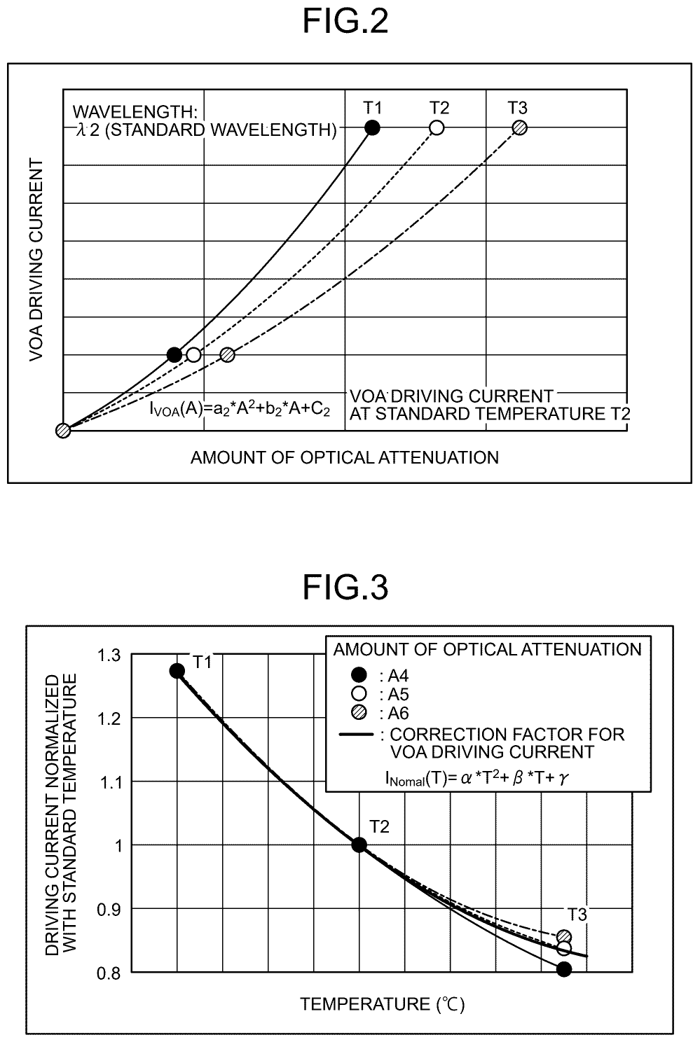

FIG. 2 is a diagram illustrating an example of quadratic curves each approximating a relation between amounts of attenuation and driving current values for a reference temperature. The optical monitor 4 successively measures amounts of attenuation by the VOA 2 for the driving current values of 0 mA, I1 mA, I2 mA, and I3 mA, at the reference temperature T1. As a result, as illustrated in FIG. 2, the setting unit 11 obtains a quadrative curve approximating a relation between amounts of attenuation and driving current values at the reference temperature T1, on the basis of amounts of attenuation A1, A2, and A3 that are results of measurement by the optical monitor 4 at the reference temperature T1. The setting unit 11 then derives Equation 1 for calculating a driving current value I_{VOA1} (A) for each amount of attenuation at the reference temperature T1, from the quadratic curve approximating the relation between the amounts of attenuation and the driving current values at the reference temperature T1.

$${I}_{VOA 1} ( A ) = a {1}^{*} {A}^{2} + b {1}^{*} A + c 1 \qquad ( 1 )$$

Furthermore, the optical monitor 4 successively measures amounts of attenuation by the VOA 2 for the driving current values of 0 mA, I1 mA, I2 mA, and I3 mA, at the reference temperature T2. As a result, as illustrated in FIG. 2, the setting unit 11 obtains a quadrative curve approximating a relation between amounts of attenuation and driving current values at the reference temperature T2, on the basis of amounts of attenuation A1, A2, and A3 that are results of measurement by the optical monitor 4 at the reference temperature T2. The setting unit 11 then derives Equation 2 for calculating a driving current value I_{VOA2} (A) for each amount of attenuation at the reference temperature T2, from the quadratic curve approximating the relation between the amounts of attenuation and the driving current values at the reference temperature T2.

$${I}_{VOA 2} ( A ) = a {2}^{*} {A}^{2} + b {2}^{*} A + c 2 \qquad ( 2 )$$

Furthermore, the optical monitor 4 successively measures amounts of attenuation by the VOA 2 for the driving current values of 0 mA, I1 mA, I2 mA, and I3 mA, at the reference temperature T3. As a result, as illustrated in FIG. 2, the setting unit 11 obtains a quadrative curve approximating a relation between amounts of attenuation and driving current values at the reference temperature T3, on the basis of amounts of attenuation A1, A2, and A3 that are results of measurement by the optical monitor 4 at the reference temperature T3. The setting unit 11 then derives Equation 3 for calculating a driving current value I_{VOA3} (A) for each amount of attenuation at the reference temperature T3, from the quadratic curve approximating the relation between the amounts of attenuation and the driving current values at the reference temperature T3.

$${I}_{VOA 3} ( A ) = a {3}^{*} {A}^{2} + b {3}^{*} A + c 3 \qquad ( 3 )$$

The control unit 5 is able to calculate a driving current value for the VOA 2, the driving current value being needed for any amount of attenuation, for each reference temperature, by using these Equations 1 to 3. However, this calculation is limited to these reference temperatures T1, T2, and T3 and the problem of not being able to calculate a driving current value for the VOA 2 at a set temperature other than the reference temperatures still remains.

In a solution to this problem, the setting unit 11 normalizes the driving current values at optional amounts of attenuation A4, A5, and A6 for each reference temperature with the driving current values at a standard temperature T2 that is the reference temperature T2, on the basis of results of calculation using Equations 1 to 3. The reference temperatures T1, T2, and T3 desirably have a relation, “T1<T2<T3 (° C.)” and the optional amounts of attenuation A4, A5, and A6 desirably have a relation, “A4<A5<A6 (dB)”. As to the optional amounts of attenuation, A4 may be equal to A1 mentioned above, A5 may be equal to A2 mentioned above, and A6 may be equal to A3 mentioned above, and the optional amounts of attenuation may be modified as appropriate. FIG. 3 is a diagram illustrating a graph having values plotted therein, the values resulting from normalization of the driving current values for the reference temperatures with the standard temperature T2.

The setting unit 11 approximates the values with quadrative curves, the values resulting from the normalization of the driving current values for the reference temperatures with the standard temperature, and obtains Equations 4 to 6 from the approximating quadratic curves for the respective attenuation amount normalization values. The setting unit 11 refers to the amount of attenuation A4 illustrated in FIG. 3 and derives Equation 4 for calculating an attenuation amount normalization value Iₙₒₘₐₗ₄ (T) for a temperature T at the amount of attenuation A4.

$${I}_{Nomal 4} ( T ) = α {1}^{*} {T}^{2} + β {1}^{*} T + γ 1 \qquad ( 4 )$$

The setting unit 11 refers to the amount of attenuation A5 illustrated in FIG. 3 and derives Equation 5 for calculating an attenuation amount normalization value Iₙₒₘₐₗ₅ (T) for a temperature T at the amount of attenuation A5.

$${I}_{Nomal 5} ( T ) = α {2}^{*} {T}^{2} + β {2}^{*} T + γ 2 \qquad ( 5 )$$

The setting unit 11 refers to the amount of attenuation A6 illustrated in FIG. 3 and derives Equation 6 for calculating an attenuation amount normalization value Iₙₒₘₐₗ₆ (T) for a temperature T at the amount of attenuation A6.

$${I}_{Nomal 6} ( T ) = α {3}^{*} {T}^{2} + β {3}^{*} T + γ 3 \qquad ( 6 )$$

The setting unit 11 obtains coefficients (α1, β1, γ1, α2, β2, γ2, α3, β3, and γ3) of each order from Equations 4 to 6. The setting unit 11 calculates the average value of the coefficients for each order (α=Average (α1, α2, α3), β=Average (β1, β2, β3), and γ=Average (γ1, γ2, γ3)). By using these average values, the setting unit 11 calculates a temperature correction factor that is a correction factor for correcting a normalized value of a driving current value for a temperature, that is, a driving current value between a standard temperature and a set temperature. This set temperatures is the peripheral temperature around the VOA 2, the peripheral temperature having been measured by the temperature monitor 3. A solid line illustrated in FIG. 3 is a quadrative curve indicating a relation for the temperature correction factor for correcting the driving current value between the standard temperature and the set temperature. The setting unit 11 derives Equation 7 for calculating a temperature correction factor Iₙₒₘₐₗ(T) by using the average value of the coefficients for each order (α=Average (α1, α2, α3), β=Average (β1, β2, β3), and γ=Average (γ1, γ2, γ3)).

$${I}_{Nomal} ( T ) = {α}^{*} {T}^{2} + {β}^{*} T + γ \qquad ( 7 )$$

$$( α = Average ( α1 , α2 , α3 ) , \\ β = Average ( β1 , β2 , β3 ) , γ = Average ( γ1 , γ2 , γ3 ) , )$$

The setting unit 11 then stores Equation 2 serving as the first function for calculating a driving current value for each amount of attenuation at the reference temperature T2 and Equation 7 serving as the second function for calculating a temperature correction factor, into the storage unit 12. That is, the storage unit 12 stores Equation 2 and Equation 7, that is, only the coefficients of Equation 2 and the coefficients of Equation 7.

Operation of the control unit 5 that sets a driving current value for obtainment of a set amount of attenuation by the VOA 2 at a set temperature and a standard wavelength by using the first function and the second function will be described next.

Firstly, the set amount of attenuation is, for example, a desired amount of attenuation that the user device 50 sets on the VOA 2. The set amount of attenuation may be automatically set in conjunction with the optical monitor 4, for example. The set temperature for the VOA 2 is, for example, a peripheral temperature around the VOA 2 and measured by the temperature monitor 3 regularly or as needed. That is, the calculation unit 13 obtains the set amount of attenuation and the set temperature for the VOA 2.

By substituting the set amount of attenuation into Equation 2, the calculation unit 13 calculates a driving current value at the standard temperature T2. Furthermore, by substituting the set temperature that is the peripheral temperature obtained from the temperature monitor 3 into Equation 7, the calculation unit 13 calculates a temperature correction factor for correcting a driving current value between the standard temperature T2 and the set temperature. Furthermore, by multiplying the driving current value calculated by Equation 2 by the temperature correction factor calculated by Equation 7, the calculation unit 13 calculates a driving current value needed for obtainment of the set amount of attenuation at the standard wavelength and the set temperature, and sets the calculated driving current value on the driving control unit 14. The driving control unit 14 supplies driving current corresponding to the set driving current value, to the VOA 2. As a result, the VOA 2 is able to achieve the set amount of attenuation at the set temperature and the standard wavelength according to the driving current from the driving control unit 14.

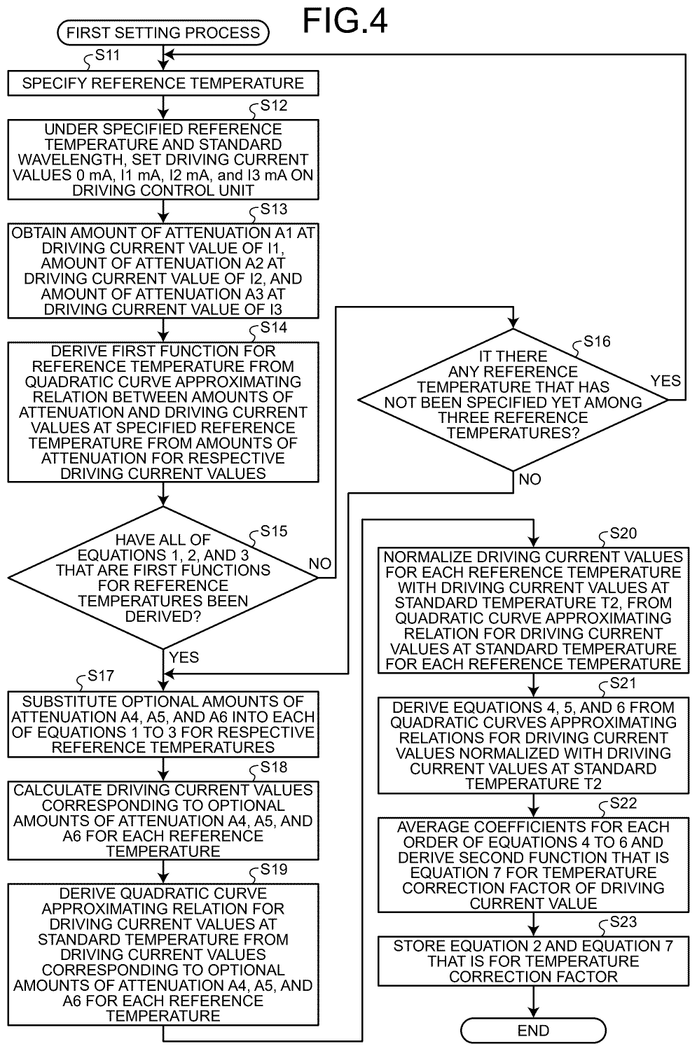

FIG. 4 is a flowchart illustrating an example of processing operation by the control unit 5, the processing operation being related to a first setting process. In FIG. 4, the setting unit 11 of the control unit 5 specifies any reference temperature from plural reference temperatures, with the wavelength of input light serving as the standard wavelength (Step S11). The reference temperatures are, for example, T1, T2, and T3. Under the specified reference temperature and the standard wavelength, the setting unit 11 successively sets the driving current values of 0 mA, I1 mA, I2 mA, and I3 mA, on the driving control unit 14 (Step S12). As a result, the driving control unit 14 successively supplies driving current corresponding to the set driving current values, to the VOA 2.

The setting unit 11 obtains an amount of attenuation for when the driving current of 0 mA is set, the amount of attenuation A1 for when the driving current of I1 mA is set, the amount of attenuation A2 for when the driving current of I2 mA is set, and the amount of attenuation A3 for when the driving current of I3 mA is set, from the optical monitor 4 (Step S13).

The setting unit 11 derives the first function for the specified reference temperature from a quadratic curve approximating a relation between amounts of attenuation and driving current values for the specified reference temperatures, the relation having been obtained from amounts of attenuation for respective driving current values (Step S14). The setting unit 11 determines whether or not all of the first functions for the reference temperatures have been derived (Step S15). All of the first functions for the reference temperatures herein are Equation 1 for the reference temperature T1, Equation 2 for the reference temperature T2, and Equation 3 for the reference temperature T3.

In a case where not all of the first functions for the reference temperatures have been derived (Step S15: No), the setting unit 11 determines whether or not there is any reference temperature that has not been specified yet among the three reference temperatures (Step S16). In a case where there is any reference temperature that has not been specified yet (Step S16: Yes), the setting unit 11 proceeds to Step S11 to specify the reference temperature that has not been specified yet.

In a case where all of the first functions for the reference temperatures have been derived (Step S15: Yes), the setting unit 11 substitutes the optional amounts of attenuation A4, A5, and A6 into Equation 1, Equation 2, and Equation 3 for the respective reference temperatures (Step S17). The setting unit 11 then calculates driving current values for each reference temperature according to the optional amounts of attenuation A4, A5, and A6 (Step S18).

The setting unit 11 derives a quadratic curve approximating a relation for driving current values at the standard temperature T2 from driving current values calculated for each reference temperature (Step S19). The setting unit 11 then normalizes the driving current values for each reference temperature with the driving current values for the standard temperature T2, from the quadratic curve derived at Step S19 (Step S20).

The setting unit 11 derives Equation 4, Equation 5, and Equation 6 each approximating a relation for driving current values normalized with the driving current values for the standard temperature T2 (Step S21). The setting unit 11 then averages coefficients for each order of Equation 4, Equation 5, and Equation 6, and derives the second function that is Equation 7 for calculating a temperature correction factor that corrects a driving current value between the standard temperature T2 and a set temperature (Step S22).

The setting unit 11 then stores Equation 2 for calculating a driving current value corresponding to a set amount of attenuation at the standard temperature T2 and Equation 7 for calculating a temperature correction factor that corrects a driving current value between the standard temperature T2 and a set temperature, into the storage unit 12 (Step S23) and ends the processing operation illustrated in FIG. 4.

In a case where there is no reference temperature that has not been specified yet (Step S16: No), the setting unit 11 proceeds to Step S17 to substitute an optional amount of attenuation in Equation 1, Equation 2, and Equation 3 for the respective reference temperatures.

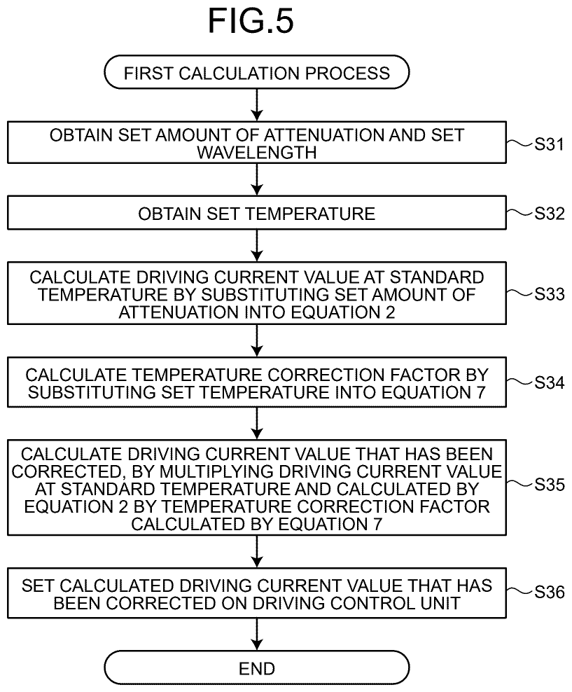

FIG. 5 is a flowchart illustrating an example of processing operation by the control unit 5, the processing operation being related to a first calculation process. In FIG. 5, the calculation unit 13 in the control unit 5 obtains a set amount of attenuation and a set wavelength (Step S31). The set amount of attenuation and the set wavelength are obtained by, for example, setting by means of the user device 50. The set wavelength is a standard wavelength. The calculation unit 13 obtains a set temperature from the temperature monitor 3 (Step S32). This set temperature is a peripheral temperature around the VOA 2, the peripheral temperature having been measured by the temperature monitor 3.

By substituting the set amount of attenuation into Equation 2, the calculation unit 13 calculates a driving current value at the standard temperature T2 (Step S33). Furthermore, by substituting the set temperature into Equation 7, the calculation unit 13 calculates a temperature correction factor (Step S34).

The calculation unit 13 multiplies the driving current value at the standard temperature T2 and calculated by Equation 2, by the temperature correction factor calculated by Equation 7, and thereby calculates a driving current value that has been corrected (Step S35). The calculation unit 13 then sets the calculated driving current value that has been corrected, on the driving control unit 14 (Step S36), and ends the processing operation illustrated in FIG. 5. The driving control unit 14 then supplies driving current corresponding to the set driving current value, to the VOA 2. As a result, the VOA 2 is able to achieve the set amount of attenuation at the set temperature.

In the control device 1 according to the first embodiment, just by use of Equation 2 and Equation 7 being stored in the storage unit 12, a driving current value for obtaining a set amount of attenuation at a set temperature is calculated, and the calculated driving current value is set on the driving control unit 14. As a result, as compared to the conventional technique, the driving current value for the set amount of attenuation at the set temperature is able to be calculated with the difference between the set temperature and the standard temperature being corrected and the amount of data being reduced, without the need for any complicated arithmetic processing. What is more, the arithmetic processing is able to be simplified with the amount of needed data being reduced and the advance preparation time period being shortened, the advance preparation time period being for calculation of the driving current value for obtaining the set amount of attenuation at the VOA 2. That is, the driving current value for obtaining the set amount of attenuation at the set temperature is able to be obtained with the temperature dependence being corrected.

Because a feedforward (FF) control method is adopted in the control device 1, an optical monitor for feedback (FB) control is not needed downstream from the VOA 2. What is more, because the FF control method is adopted in the control device 1, the multiple loop problem is also able to be solved.

What is more, because the temperature monitor 3 and the control unit 5 are installed in the module in the control device 1, a driving circuit is not needed, an area for mounting is able to be obtained, advance measurement needed for control at the user device 50 is not needed, and the time period for advance preparation is thus able to be shortened.

For convenience of description, the case where the optical monitor 4 is built in the control device 1 has been described as an example, but if the first function and the second function are stored in the storage unit 12 beforehand, the optical monitor 4 is not needed.

The case where Equation 2 and Equation 7 of the attenuation amount characteristics based on the standard temperature are used has been described as an example with respect to the control device 1 according to the first embodiment. However, without being limited to the standard temperature, attenuation amount characteristics based on a standard wavelength of input light may be used, and an embodiment related to such a modification will hereinafter be described as a second embodiment.

### (b) Second Embodiment

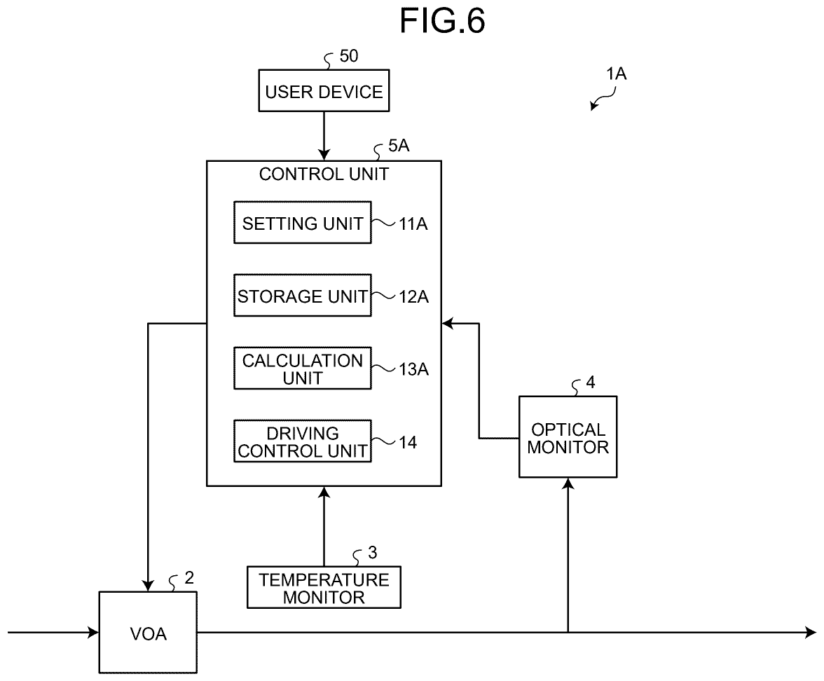

FIG. 6 is a block diagram illustrating an example of a control device 1A according to the second embodiment. By assignment of the same reference signs to components that are the same as those of the control device 1 according to the first embodiment, any redundant description of the same components and operation thereof will be omitted. The control device 1A according to the second embodiment is different from the control device 1 according to the first embodiment in that the control device 1A has a control unit 5A that calculates a driving current value for a set amount of attenuation by using attenuation amount characteristics based on a standard wavelength of input light.

The control unit 5A controls a VOA 2. The control unit 5A controls the VOA 2 by using the attenuation amount characteristics based on the standard wavelength of the input light, the attenuation amount characteristics having been obtained beforehand. On the basis of the attenuation amount characteristics based on the standard wavelength, the set amount of attenuation for the VOA 2, and a set wavelength for input light, the control unit 5A calculates a driving current value for obtaining the set amount of attenuation at a set temperature and the set wavelength. The control unit 5A then supplies driving current corresponding to the calculated driving current value, to the VOA 2. A user device 50 sets the set amount of attenuation and the set wavelength, on the control device 1A.

The control unit 5A has a setting unit 11A, a storage unit 12A, a calculation unit 13A, and a driving control unit 14. The setting unit 11A calculates a third function and a fourth function that are some of the attenuation amount characteristics, and stores the third function and fourth function calculated, into the storage unit 12A. The third function is an equation of a quadratic curve approximating a relation between amounts of attenuation by the VOA 2 and driving current values at the standard wavelength described later. The fourth function is an equation for calculating a wavelength correction factor that corrects a driving current value between the set wavelength and the standard wavelength.

By substituting the set amount of attenuation into the third function, the calculation unit 13A calculates a driving current value at the standard wavelength. By substituting the set wavelength into the fourth function, the calculation unit 13A calculates a wavelength correction factor at the set wavelength. Furthermore, on the basis of the driving current value at the standard wavelength and calculated by the third function and the wavelength correction factor at the set wavelength and calculated by the fourth function, the calculation unit 13A calculates a driving current value for obtaining the set amount of attenuation at the set wavelength and sets the calculated driving current value on the driving control unit 14. The driving control unit 14 supplies driving current corresponding to the set driving current value, to the VOA 2.

Instead of being used for FB control, an optical monitor 4 is used to measure amounts of attenuation by the VOA 2, the amounts of attenuation being needed for calculation of the attenuation amount characteristics.

Operation of the control unit 5A for setting the third function and the fourth function will be described next. The optical monitor 4 successively measures amounts of attenuation by the VOA 2 under predetermined driving current conditions for each of at least three reference wavelengths of λ1 nm, λ2 nm, and λ3 nm beforehand. The predetermined driving current conditions are conditions where the VOA 2 is driven under a standard temperature T2 at, for example, four driving current values of 0 mA, I1 mA, I2 mA, and I3 mA. The number of the driving current values is not limited to four and may be modified as appropriate to be two or more. The standard temperature is obtained from a temperature monitor 3.

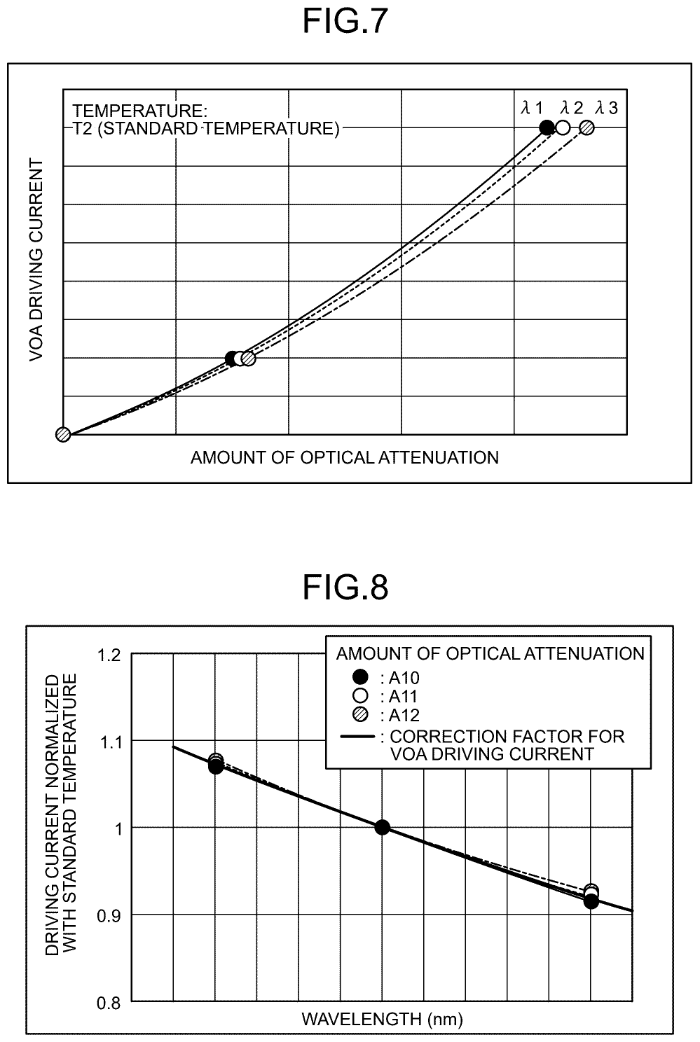

FIG. 7 is a diagram illustrating an example of quadratic curves each approximating a relation between amounts of attenuation and driving current values for a reference wavelength. The optical monitor 4 successively measures amounts of attenuation by the VOA 2 for the driving current values of 0 mA, I1 mA, I2 mA, and I3 mA at the reference wavelength λ1, under the standard temperature T2. As a result, as illustrated in FIG. 7, the setting unit 11A obtains a quadrative curve approximating a relation between amounts of attenuation and driving current values at the reference wavelength λ1, on the basis of amounts of attenuation A7, A8, and A9 that are results of measurement by the optical monitor 4 at the reference wavelength λ1. The setting unit 11A then derives Equation 8 for calculating a driving current value I_{VOA7} (A) for each amount of attenuation at the reference wavelength λ1, from the quadratic curve approximating the relation between the amounts of attenuation and the driving current values at the reference wavelength λ1.

$${I}_{VOA 7} ( A ) = d {1}^{*} {A}^{2} + e {1}^{*} A + f 1 \qquad ( 8 )$$

Furthermore, the optical monitor 4 successively measures amounts of attenuation by the VOA 2 for the driving current values of 0 mA, I1 mA, I2 mA, and I3 mA, at the reference wavelength λ2. As a result, as illustrated in FIG. 7, the setting unit 11A obtains a quadrative curve approximating a relation between amounts of attenuation and driving current values at the reference wavelength λ2, on the basis of amounts of attenuation A7, A8, and A9 that are results of measurement by the optical monitor 4 at the reference wavelength λ2. The setting unit 11A then derives Equation 9 for calculating a driving current value I_{VOA8} (A) for each amount of attenuation at the reference wavelength λ2, from the quadratic curve approximating the relation between the amounts of attenuation and the driving current values at the reference wavelength λ2.

$${I}_{VOA 8} ( A ) = d {2}^{*} {A}^{2} + e {2}^{*} A + f 2 \qquad ( 9 )$$

Furthermore, the optical monitor 4 successively measures amounts of attenuation by the VOA 2 for each of the driving current values of 0 mA, I1 mA, I2 mA, and I3 mA, at the reference wavelength λ3. As a result, as illustrated in FIG. 7, the setting unit 11A obtains a quadrative curve approximating a relation between amounts of attenuation and driving current values at the reference wavelength λ3, on the basis of amounts of attenuation A7, A8, and A9 that are results of measurement by the optical monitor 4 at the reference wavelength λ3. The setting unit 11A then derives Equation 10 for calculating a driving current value I_{VOA9} (A) for each amount of attenuation at the reference wavelength λ3, from the quadratic curve approximating the relation between the amounts of attenuation and the driving current values at the reference wavelength λ3.

$${I}_{VOA 9} ( A ) = d {3}^{*} {A}^{2} + e {3}^{*} A + f 3 \qquad ( 10 )$$

The control unit 5A is able to calculate a driving current value for the VOA 2, the driving current value being needed for any amount of attenuation, for each reference wavelength, by using these Equations 8 to 10. However, this calculation is limited to these reference wavelengths λ1, λ2, and λ3 and the problem of not being able to calculate a driving current value for the VOA 2 at a set wavelength other than the reference wavelengths still remains.

In a solution to this problem, the setting unit 11A normalizes the driving current values at each reference wavelength for optional amounts of attenuation A10, A11, and A12, with driving current values at a standard wavelength λ2 that is the reference wavelength λ2, on the basis of results of calculation by Equations 8 to 10. The reference wavelengths λ1, λ2, and λ3 desirably have a relation, “λ1<λ2<λ3”, and the optional amounts of attenuation A10, A11, and A12 desirably have a relation, “A10<A11<A12 (dB)”. As to the optional amounts of attenuation, A10 may be equal to A7 mentioned above, A11 may be equal to A8 mentioned above, and A12 may be equal to A9 mentioned above, and the optional amounts of attenuation may be modified as appropriate. FIG. 8 is a diagram illustrating a graph having values plotted therein, the values resulting from normalization of the driving current values at each reference wavelength with the standard wavelength λ2.

The setting unit 11A approximates the values with quadrative curves, the values resulting from normalization of the driving current values at each reference wavelengths with the standard wavelength λ2, and obtains Equations 11 to 13 from the approximating quadratic curves for the respective attenuation amount normalization values. The setting unit 11A refers to the amount of attenuation A10 illustrated in FIG. 8 and derives Equation 11 for calculating an attenuation amount normalization value Iₙₒₘₐₗ₁₀ (λ) for a wavelength λ at the amount of attenuation A10 under the standard temperature T2.

$${I}_{Nomal 10} ( λ ) = δ {1}^{*} {λ}^{2} + ε {1}^{*} λ + ζ 1 \qquad ( 11 )$$

The setting unit 11A refers to the amount of attenuation A11 illustrated in FIG. 8 and derives Equation 12 for calculating an attenuation amount normalization value Iₙₒₘₐₗ₁₁ (λ) for a wavelength λ at the amount of attenuation A11 under the standard temperature T2.

$${I}_{Nomal 11} ( λ ) = δ {2}^{*} {λ}^{2} + ε {2}^{*} λ + ζ 2 \qquad ( 12 )$$

The setting unit 11A refers to the amount of attenuation A12 illustrated in FIG. 8 and derives Equation 13 for calculating an attenuation amount normalization value Iₙₒₘₐₗ₁₂ (λ) for a wavelength λ at the amount of attenuation A12 under the standard temperature T2.

$${I}_{Nomal 12} ( λ ) = δ {3}^{*} {λ}^{2} + ε {3}^{*} λ + ζ 3 \qquad ( 13 )$$

The setting unit 11A obtains coefficients (δ1, ε1, ζ1, δ2, ε2, ζ2, δ3, ε3, and ζ3) of each order from Equations 11 to 13. The setting unit 11A calculates the average value of coefficients for each order (δ=Average (δ1, δ2, δ3), ε=Average (ε1, ε2, ε3), and ζ=Average (ζ1, ζ2, ζ3)). By using these average values, the setting unit 11A then calculates a wavelength correction factor that is a correction factor for correcting a normalized value of a driving current value for a wavelength, that is, a driving current value between a standard wavelength and a set wavelength. The set wavelength is a wavelength of input light set by the user device 50. A solid line illustrated in FIG. 8 is a quadrative curve indicating a relation for the wavelength correction factor for correcting the driving current value between the standard wavelength and the set wavelength. The setting unit 11A derives Equation 14 for calculating a wavelength correction factor by using the average values of the coefficients for the respective orders (δ=Average (δ1, δ2, δ3), ε=Average (ε1, ε2, ε3), and ζ=Average (ζ1, ζ2, ζ3)).

$${I}_{Nomal} ( λ ) = {δ}^{*} {λ}^{2} + {ε}^{*} λ + ζ \qquad ( 14 )$$

$$( δ = Average ( δ1 , δ2 , δ3 ) , \\ ε = Average ( ε1 , ε2 , ε3 ) , ζ = Average ( ζ1 , ζ2 , ζ3 ) , )$$

The setting unit 11A then stores Equation 9 serving as the third function for calculating a driving current value for each amount of attenuation at the reference wavelength λ2 and Equation 14 serving as the fourth function for calculating a wavelength correction factor, into the storage unit 12A. That is, the storage unit 12A stores Equation 9 and Equation 14, that is, only the coefficients of Equation 9 and the coefficients of Equation 14.

Operation of the control unit 5A that sets a driving current value for obtaining a set amount of attenuation for the VOA 2 at a set wavelength and a standard temperature by using the third function and the fourth function will be described next.

Firstly, the set amount of attenuation is, for example, a desired amount of attenuation by the VOA 2 that the user device 50 sets on the control device 1A. The set amount of attenuation may be automatically set in conjunction with the optical monitor 4, for example. The set temperature for the VOA 2 is, for example, a peripheral temperature around the VOA 2 measured by the temperature monitor 3 regularly or as needed. That is, the calculation unit 13A obtains the set amount of attenuation and the set temperature for the VOA 2.

By substituting the set amount of attenuation into Equation 9, the calculation unit 13A calculates a driving current value at the standard wavelength λ2. Furthermore, by substituting the set wavelength into Equation 14, the calculation unit 13A calculates a wavelength correction factor for correcting a driving current value between the standard wavelength and the set wavelength. Furthermore, the calculation unit 13A calculates a driving current value needed for obtainment of the set amount of attenuation at the standard temperature and set wavelength, by multiplying the driving current value calculated by Equation 9 by the wavelength correction factor calculated by Equation 14. The calculation unit 13A sets the calculated driving current value at the standard temperature and set wavelength, on the driving control unit 14. The driving control unit 14 supplies driving current corresponding to the set driving current value, to the VOA 2. As a result, the VOA 2 is able to achieve the set amount of attenuation at the standard temperature and set wavelength according to the driving current from the driving control unit 14.

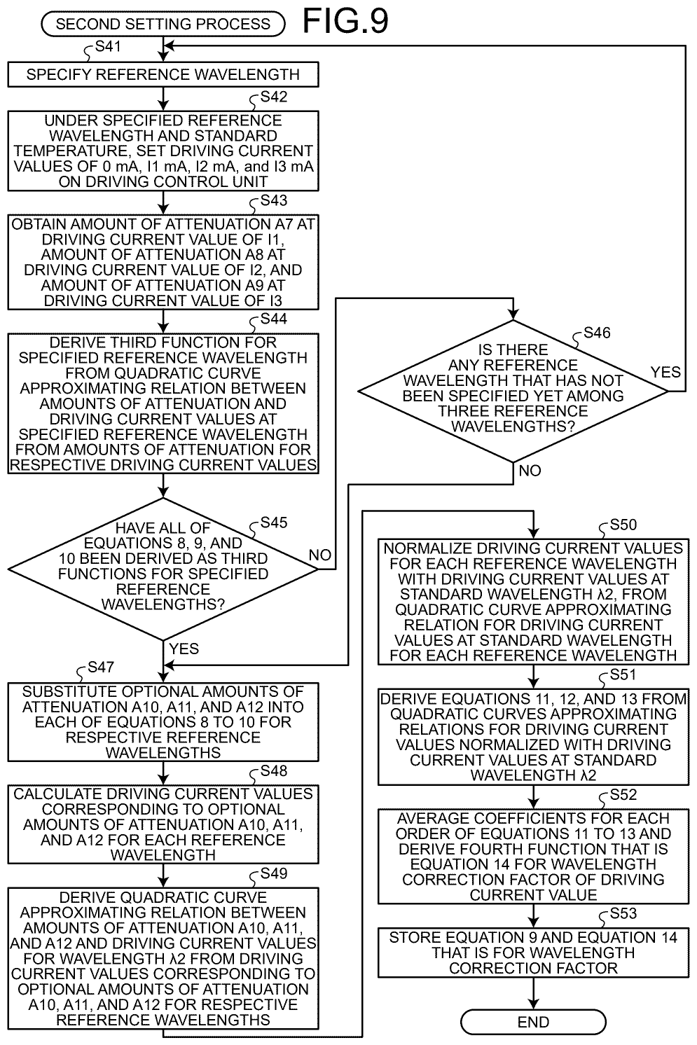

FIG. 9 is a flowchart illustrating an example of processing operation by the control unit 5A, the processing operation being related to a second setting process. In FIG. 9, the setting unit 11A of the control unit 5A specifies any reference wavelength from plural reference wavelengths, under the standard temperature T2 (Step S41). The reference wavelengths are, for example, λ1, λ2, and λ3. Under the specified reference wavelength and the standard temperature T2, the setting unit 11A successively sets the driving current values, 0 mA, I1 mA, I2 mA, and I3 mA, on the driving control unit 14 (Step S42). As a result, the driving control unit 14 successively supplies driving current corresponding to the set driving current values, to the VOA 2.

The setting unit 11A obtains an amount of attenuation for when the driving current of 0 mA is set, the amount of attenuation A7 for when the driving current of I1 mA is set, the amount of attenuation A8 for when the driving current of I2 mA is set, and the amount of attenuation A9 for when the driving current of I3 mA is set, from the optical monitor 4 (Step S43).

The setting unit 11A derives the third function for the specified reference wavelength from a quadratic curve approximating a relation between amounts of attenuation and driving current values for the specified reference wavelength, the relation having been obtained from amounts of attenuation for respective driving current values (Step S44). The setting unit 11A determines whether or not all of the third functions for the reference wavelengths have been derived (Step S45). All of the third functions for the reference wavelengths herein are Equation 8 for the reference wavelength λ1, Equation 9 for the reference wavelength λ2, and Equation 10 for the reference wavelength λ3.

In a case where not all of the third functions for the reference wavelengths have been derived (Step S45: No), the setting unit 11A determines whether or not there is any reference wavelength that has not been specified yet among the three reference wavelengths (Step S46). In a case where there is any reference wavelength that has not been specified yet (Step S46: Yes), the setting unit 11A proceeds to Step S41 to specify the reference wavelength that has not been specified yet.

In a case where all of the third functions for the reference wavelengths have been derived (Step S45: Yes), the setting unit 11A substitutes the optional amounts of attenuation A10, A11, and A12 into Equation 8, Equation 9, and Equation 10 for the respective reference wavelengths (Step S47). The setting unit 11A then calculates driving current values for each reference wavelength according to the optional amounts of attenuation A10, A11, and A12 (Step S48).

The setting unit 11A derives a quadratic curve approximating a relation for driving current values at the standard wavelength λ2 from driving current values calculated for each reference wavelength (Step S49). The setting unit 11A then normalizes the driving current values for each reference wavelength with the driving current values for the standard wavelength λ2, from the quadratic curve derived at Step S49 (Step S50).

The setting unit 11A derives Equation 11, Equation 12, and Equation 13 from quadratic curves approximating relations for driving current values normalized with the driving current values for the standard wavelength λ2 (Step S51). The setting unit 11A averages the coefficients for each order of Equation 11, Equation 12, and Equation 13 and derives the fourth function that is Equation 14 for calculating a wavelength correction factor that corrects a driving current value between the standard wavelength λ2 and the set wavelength (Step S52).

The setting unit 11A then stores Equation 9 for calculating a driving current value corresponding to the set amount of attenuation for the standard wavelength λ2 and Equation 14 for calculating a wavelength correction factor that corrects a driving current value between the standard wavelength λ2 and the set wavelength, into the storage unit 12A (Step S53) and ends the processing operation illustrated in FIG. 9.

In a case where there is no reference wavelength that has not been specified yet (Step S46: No), the setting unit 11A proceeds to Step S47 to substitute an optional amount of attenuation into Equation 8, Equation 9, and Equation 10 for the respective reference wavelengths.

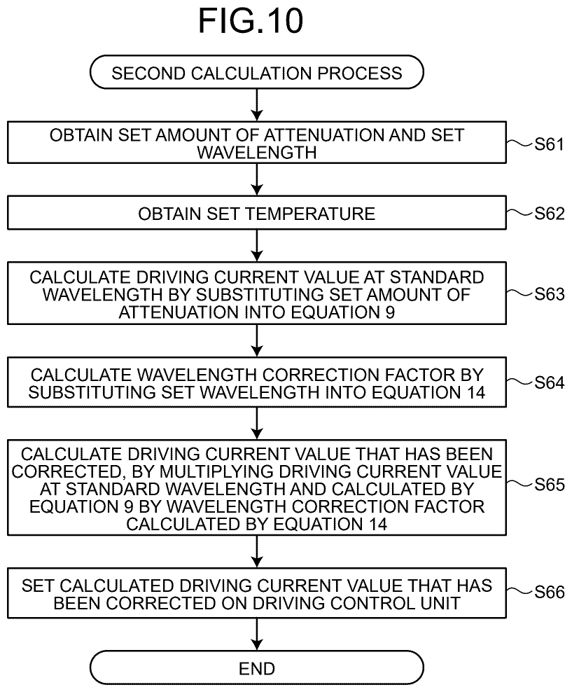

FIG. 10 is a flowchart illustrating an example of processing operation by the control unit 5A, the processing operation being related to a second calculation process. In FIG. 10, the calculation unit 13A in the control unit 5A obtains a set amount of attenuation and a set wavelength (Step S61). The set amount of attenuation and the set wavelength are obtained from, for example, the user device 50. The calculation unit 13A obtains a set temperature from the temperature monitor 3 (Step S62). This set temperature is a peripheral temperature around the VOA 2, the peripheral temperature having been measured by the temperature monitor 3.

By substituting the set amount of attenuation into Equation 9, the calculation unit 13A calculates a driving current value at the standard wavelength λ2 (Step S63). Furthermore, by substituting the set wavelength into Equation 14, the calculation unit 13A calculates a wavelength correction factor (Step S64).

The calculation unit 13A multiplies the driving current value at the standard wavelength λ2 and calculated by Equation 9, by the wavelength correction factor calculated by Equation 14, and thereby calculates a driving current value that has been corrected (Step S65). The calculation unit 13A then sets the calculated driving current value that has been corrected on the driving control unit 14 (Step S66) and ends the processing operation illustrated in FIG. 10. The driving control unit 14 then supplies driving current corresponding to the set driving current value, to the VOA 2. As a result, the VOA 2 is able to achieve the set amount of attenuation at the set wavelength.

In the control device 1A according to the second embodiment, just by use of Equation 9 and Equation 14 stored in the storage unit 12A, a driving current value for obtaining a set amount of attenuation at a set wavelength is calculated, and the calculated driving current value is set on the driving control unit 14. As a result, as compared to the conventional technique, the driving current value for the set amount of attenuation at the set wavelength is able to be calculated with the difference between the set wavelength and the standard wavelength being corrected and the amount of data being reduced, without the need for any complicated arithmetic processing. What is more, the arithmetic processing is able to be simplified with the amount of needed data being reduced and the advance preparation time period being shortened, the advance preparation time period being for calculation of the driving current value for obtaining the set amount of attenuation at the VOA 2. That is, the driving current value for obtaining the set amount of attenuation at the set wavelength is able to be obtained with the temperature dependence being corrected.

Because the FF control method is adopted in the control device 1A, an optical monitor for FB control is not needed downstream from the VOA 2. What is more, because the FF control method is adopted in the control device 1A, the multiple loop problem is also able to be solved.

What is more, because the temperature monitor 3 and the control unit 5A are installed in a module in the control device 1A, a driving circuit is not needed, an area for mounting is able to be obtained, advance measurement needed for control at the user device 50 is not needed, and the time period for advance preparation is thus able to be shortened.

For convenience of description, the case where the optical monitor 4 is built in the control device 1A has been described as an example, but if the third function and the fourth function have been stored in the storage unit 12A beforehand, the optical monitor 4 is not needed.

The case where Equation 2 and Equation 7 of the attenuation amount characteristics based on a standard temperature are used has been described as an example with respect to the control device 1 according to the first embodiment, and the case where Equation 9 and Equation 14 of the attenuation amount characteristics based on a standard wavelength are used has been described as an example with respect to the control device 1A according to the second embodiment. However, without being limited to these examples, Equation 2 and Equation 7 based on a standard temperature and Equation 14 based on a standard wavelength may be used in combination, and an embodiment related such a modification will hereinafter be described as a third embodiment.

### (c) Third Embodiment

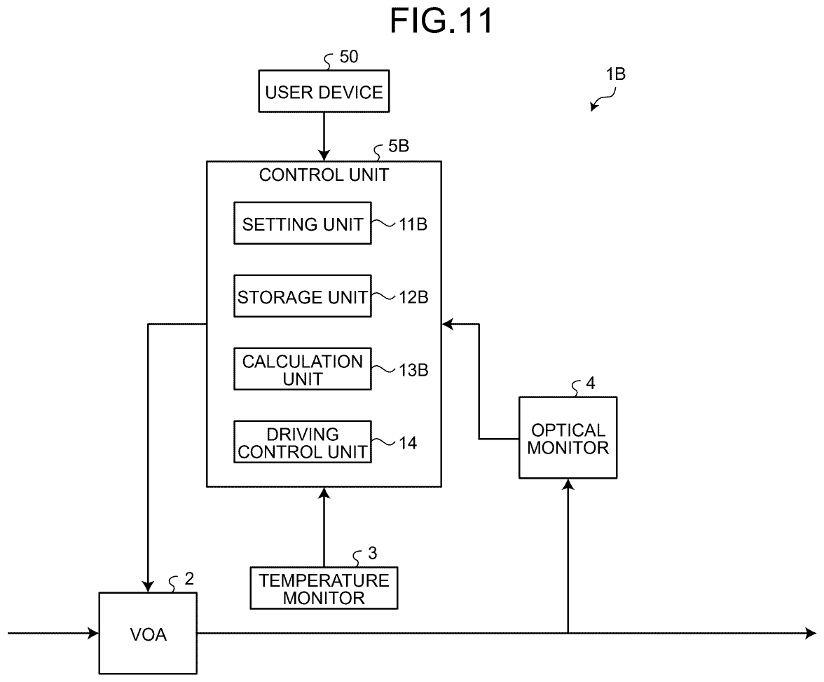

FIG. 11 is a block diagram illustrating an example of a control device 1B according to the third embodiment. By assignment of the same reference signs to components that are the same as those of the control device 1 or 1A according to the first and second embodiments, any redundant description of the same components and operation thereof will be omitted. The control device 1B according to the third embodiment is different from the control device 1 or 1A according to the first and second embodiments in that the control device 1B has a control unit 5B that calculates a driving current value for a set amount of attenuation by using Equation 2 and Equation 7 that are based on a standard temperature, in combination with Equation 14 based on a standard wavelength.

The control unit 5B has a setting unit 11B, a storage unit 12B, a calculation unit 13B, and a driving control unit 14. The setting unit 11B calculates Equation 2 and Equation 7 based on a standard temperature and stores the calculated Equation 2 as a first function and the calculated Equation 7 as a second function, into the storage unit 12B. The setting unit 11B also calculates Equation 14 based on a standard wavelength and stores the calculated Equation 14 as a fourth function, into the storage unit 12B.

Operation of the control unit 5B that calculates a driving current value for obtaining a set amount of attenuation at a set wavelength and a set temperature by using the first function, the second function, and the fourth function will be described next.

Firstly, the set amount of attenuation is, for example, a desired amount of attenuation by a VOA 2, the desired amount being set by a user device 50. The set amount of attenuation may be automatically set in conjunction with an optical monitor 4, for example. The set wavelength is a desired wavelength of input light set by the user device 50, for example. The set temperature is, for example, a peripheral temperature around the VOA 2 measured by a temperature monitor 3 regularly or as needed. The calculation unit 13B obtains the set amount of attenuation, the set wavelength, and the set temperature.

By substituting the set amount of attenuation into Equation 2, the calculation unit 13B calculates a driving current value at a standard temperature T2. Furthermore, by substituting the set temperature that is the peripheral temperature obtained from the temperature monitor 3 into Equation 7, the calculation unit 13B calculates a temperature correction factor for correcting driving current between the standard temperature and the set temperature. Furthermore, by substituting the set wavelength into Equation 14, the calculation unit 13B calculates a wavelength correction factor for correcting driving current between the standard wavelength and the set wavelength.

The calculation unit 13B calculates a driving current value needed for obtainment of the set amount of attenuation at the set temperature and set wavelength, by multiplying the driving current value calculated by Equation 2 by the temperature correction factor calculated by Equation 7 and the wavelength correction factor calculated by Equation 14. The calculation unit 13B then sets the calculated driving current value on the driving control unit 14. The driving control unit 14 supplies driving current corresponding to the set driving current value, to the VOA 2.

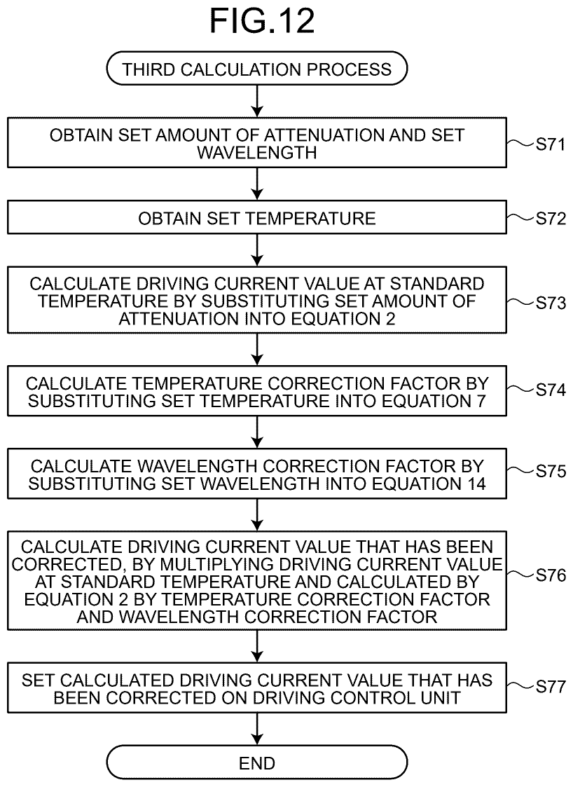

FIG. 12 is a flowchart illustrating an example of processing operation by the control unit 5B, the processing operation being related to a third calculation process. In FIG. 12, the calculation unit 13B in the control unit 5B obtains a set amount of attenuation and a set wavelength (Step S71). The set amount of attenuation and the set wavelength are obtained from, for example, the user device 50. The calculation unit 13B obtains a set temperature from the temperature monitor 3 (Step S72).

By substituting the set amount of attenuation into Equation 2, the calculation unit 13B calculates a driving current value at the standard temperature T2 (Step S73). Furthermore, by substituting the set temperature into Equation 7, the calculation unit 13B calculates a temperature correction factor (Step S74). Furthermore, by substituting the set wavelength into Equation 14, the calculation unit 13B calculates a wavelength correction factor (Step S75).

The calculation unit 13B multiplies the driving current value at the standard temperature T2 and calculated by Equation 2 by the temperature correction factor calculated by Equation 7 and the wavelength correction factor calculated by Equation 14 and thereby calculates a driving current value that has been corrected (Step S76). The calculation unit 13B then sets the calculated driving current value that has been corrected, on the driving control unit 14 (Step S77), and ends the processing operation illustrated in FIG. 12. The driving control unit 14 then supplies driving current corresponding to the set driving current value, to the VOA 2. As a result, the VOA 2 is able to achieve the set amount of attenuation at the set temperature and set wavelength.

In the control device 1B according to the third embodiment, just by use of Equation 2, Equation 7, and Equation 14 being stored in the storage unit 12B, a driving current value for obtaining a set amount of attenuation at a set wavelength and a set temperature is calculated, and the calculated driving current value is set on the driving control unit 14. As a result, as compared to the conventional technique, the driving current value for the set amount of attenuation at the set temperature and set wavelength is able to be calculated with the difference between the set temperature and the standard temperature and the difference between the set wavelength and the standard wavelength both being corrected and the amount of data being reduced, without the need for any complicated arithmetic processing. What is more, the arithmetic processing is able to be simplified with the amount of needed data being reduced and the advance preparation time period being shortened, the advance preparation time period being for calculation of the driving current value for achieving the set amount of attenuation at the VOA 2. That is, the driving current value for obtaining the set amount of attenuation at the set temperature and set wavelength is able to be obtained with the temperature dependence and wavelength dependence being corrected.

Because the FF control method is adopted in the control device 1B, an optical monitor for FB control is not needed downstream from the VOA 2. What is more, because the FF control method is adopted in the control device 1B, the multiple loop problem is also able to be solved.

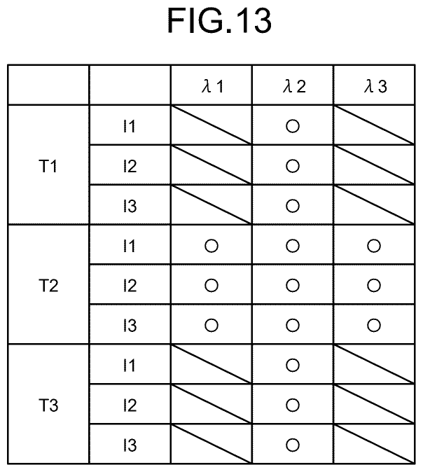

FIG. 13 is a diagram illustrating an example of combinations of measurement conditions for obtainment of the attenuation amount characteristics at the control device 1B according to the third embodiment. Under a reference temperature T1, the setting unit 11B executes measurement three times for driving current values of I1 mA, 12 mA, and I3 mA at a standard wavelength \2. Furthermore, under a reference temperature T3, the setting unit 11B executes measurement three times for the driving current values of I1 mA, I2 mA, and I3 mA at the standard wavelength λ2.

Furthermore, under the reference temperature T2, the setting unit 11B executes measurement three times for the driving current values of I1 mA, I2 mA, and I3 mA at a reference wavelength λ1. Under the reference temperature T2, the setting unit 11B executes measurement three times for the driving current values of I1 mA, I2 mA, and 13 mA at a reference wavelength λ2. Under the reference temperature T2, the setting unit 11B executes measurement three times for driving current values of I1 mA, I2 mA, and 13 mA at a reference wavelength λ3.

That is, as illustrated in FIG. 13, the setting unit 11B is able to obtain Equation 2, Equation 7, and Equation 14 through measurement processing of 15 times in total. What is more, because the number of coefficients for the orders in each of the three equations is three, a total of just nine coefficients are to be stored in the storage unit 12B and the amount of data is thus able to be minimized as compared to the conventional technique.

The case where a driving current value at a standard temperature is calculated by substituting a set amount of attenuation from the user device 50 into Equation 2 has been described as an example with respect to the control device 1B according to the third embodiment, but without being limited to this example, an embodiment related to a modification of this example will hereinafter be described as a fourth embodiment.

### (d) Fourth Embodiment

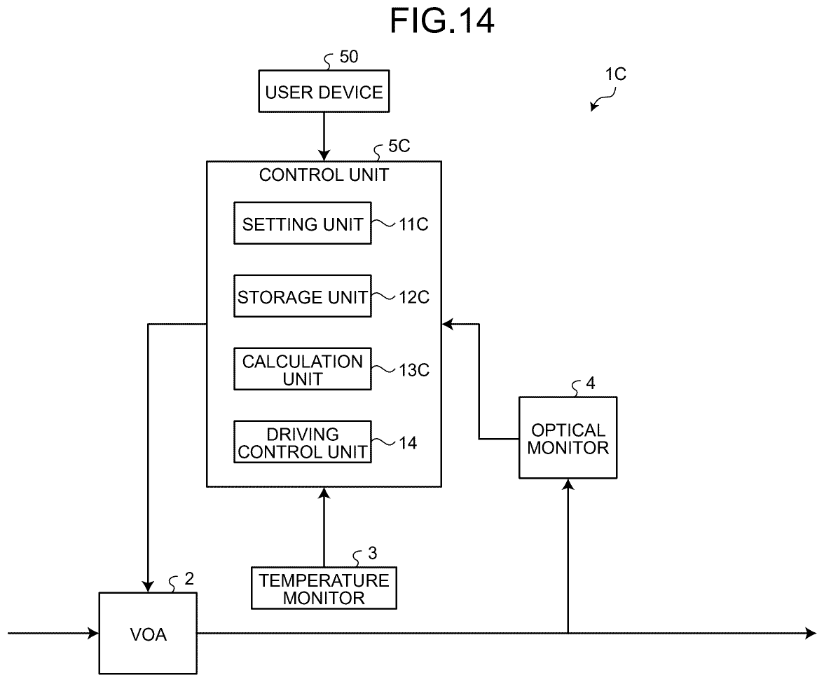

FIG. 14 is a block diagram illustrating an example of a control device 1C according to the fourth embodiment. By assignment of the same reference signs to components that are the same as those of the control device 1B according to the third embodiment, any redundant description of the same components and operation thereof will be omitted. The control device 1C according to the fourth embodiment is different from the control device 1B according to the third embodiment in that in the control device 1C, a set amount of attenuation obtained from a user device 50 is subjected to wavelength correction, and the set amount of attenuation that has been subjected to the wavelength correction is substituted into Equation 2.

A control unit 5C of the control device 1C has a setting unit 11C, a storage unit 12C, a calculation unit 13C, and a driving control unit 14. The setting unit 11C calculates Equation 2 and Equation 7 based on a set temperature and stores the calculated Equation 2 as a first function and the calculated Equation 7 as a second function, into the storage unit 12C. The setting unit 11C also calculates Equation 14 based on a set wavelength and stores the calculated Equation 14 as a fourth function, into the storage unit 12C.

Furthermore, the setting unit 11C calculates a fifth function and stores the calculated fifth function into the storage unit 12C. An optical monitor 4 successively measures amounts of attenuation by a VOA 2 at driving current values of 0 mA, I1 mA, I2 mA, and I3 mA under a standard temperature T2 and a standard wavelength λ2 beforehand. Under the standard temperature T2 and the standard wavelength λ2, the optical monitor 4 successively obtains a value of attenuation at the driving current value of 0 mA, an amount of attenuation λ1 at the driving current value of I1 mA, an amount of attenuation λ2 at the driving current value of I2 mA, and an amount of attenuation λ3 at the driving current value of I3 mA.

The setting unit 11C then derives Equation 15 for calculating an amount of attenuation at each driving current value for the standard temperature T2 from a quadratic curve approximating a relation between amounts of attenuation and driving current values at the standard temperature T2 from the amounts of attenuation λ1, λ2, and λ3 at the respective driving current values. The setting unit 11C then stores the derived Equation 15 as the fifth function into the storage unit 12C.

$${VOA}_{ATT} ( I ) = {g}^{*} {I}^{2} + {h}^{*} I + i \qquad ( 15 )$$

Operation of the control unit 5C that sets a driving current value for obtaining a set amount of attenuation at a set wavelength and a set temperature by using the first function, the second function, the fourth function, and the fifth function will be described next.

Firstly, the set amount of attenuation is, for example, a desired amount of attenuation that a user device 50 sets. The set wavelength is a wavelength of input light set by the user device 50, for example. The set temperature is, for example, a peripheral temperature around the VOA 2 measured by a temperature monitor 3 regularly or as needed. The setting unit 11C calculates a set amount of attenuation that has been subjected to wavelength correction, by multiplying the set amount of attenuation by a wavelength correction factor. Therefore, the calculation unit 13C obtains the set amount of attenuation, the set amount of attenuation that has been subjected to the wavelength correction, the set wavelength, and the set temperature.

By substituting the set amount of attenuation that has been subjected to the wavelength correction into Equation 2, the calculation unit 13C calculates a first driving current value at the standard temperature T2. Furthermore, by substituting the set wavelength into Equation 14, the calculation unit 13C calculates a wavelength correction factor for correcting a driving current value between the standard wavelength and the set wavelength.

The calculation unit 13C multiplies the first driving current value at the standard temperature T2 and calculated by Equation 2 by the wavelength correction factor calculated by Equation 14 and thereby calculates a second driving current value that has been corrected. By substituting the calculated second driving current value that has been corrected into Equation 15, the calculation unit 13C calculates an amount of attenuation that has been corrected.

Furthermore, by substituting the amount of attenuation that has been corrected into Equation 2, the calculation unit 13C calculates a third driving current value at the standard temperature T2. Furthermore, by substituting the set temperature that is the peripheral temperature into Equation 7, the calculation unit 13C calculates a temperature correction factor for correcting driving current between the standard temperature and the set temperature. The calculation unit 13C then multiplies the calculated third driving current value by the temperature correction factor, thereby calculates a fourth driving current value that has been corrected, and sets the calculated fourth driving current value on the driving control unit 14.

The driving control unit 14 supplies driving current corresponding to the fourth driving current value calculated by the calculation unit 13C, to the VOA 2. As a result, the VOA 2 is able to achieve the set amount of attenuation at the set temperature and set wavelength according to the driving current from the driving control unit 14.

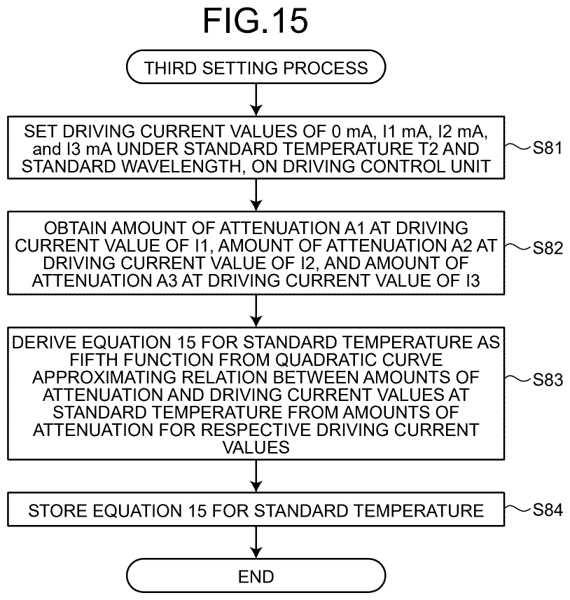

FIG. 15 is a flowchart illustrating an example of processing operation by the control unit 5C, the processing operation being related to a third setting process. In FIG. 15, the setting unit 11C of the control unit 5C successively sets the driving current values of 0 mA, I1 mA, I2 mA, and I3 mA on the driving control unit 14 under the standard temperature T2 and the standard wavelength λ2 (Step S81). As a result, the driving control unit 14 successively supplies driving current corresponding to the set driving current values to the VOA 2.

The setting unit 11C successively obtains, from the optical monitor 4, an amount of attenuation for when the driving current of 0 mA is set, the amount of attenuation λ1 for when the driving current of I1 mA is set, the amount of attenuation λ2 for when the driving current 12 mA is set, and the amount of attenuation λ3 for when the driving current 13 mA is set (Step S82).

The setting unit 11C calculates Equation 15 that is the fifth function for the standard temperature T2 from a quadratic curve approximating a relation between amounts of attenuation and driving current values at the standard temperature T2 from the amounts of attenuation at the respective driving current values (Step S83). The setting unit 11C stores the derived Equation 15 for the standard temperature T2 into the storage unit 12C (Step S84) and ends the processing operation illustrated in FIG. 15.

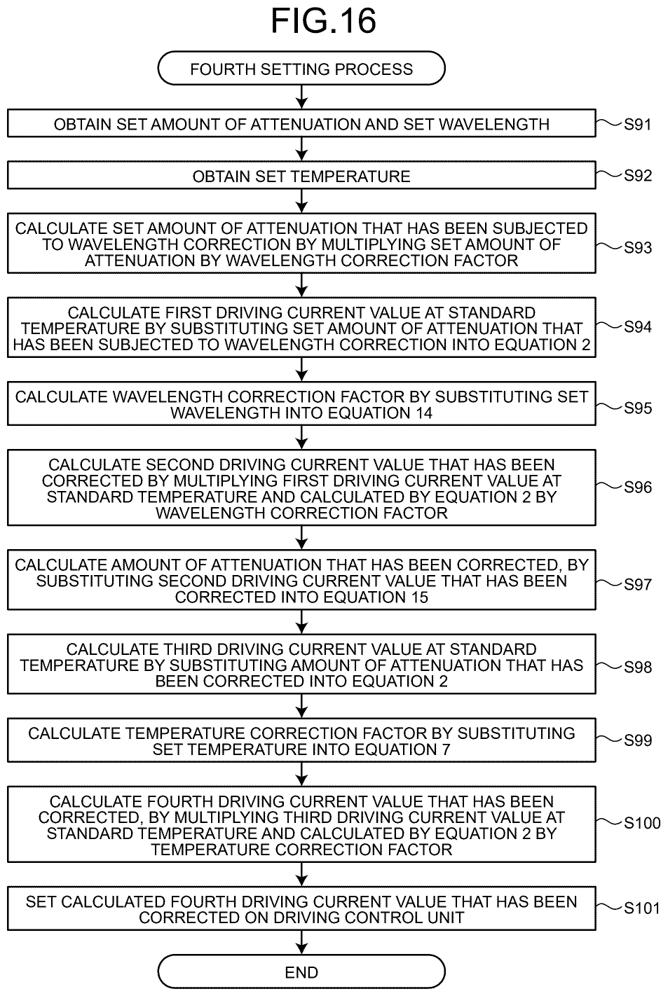

FIG. 16 is a flowchart illustrating an example of processing operation by the control unit 5C, the processing operation being related to a fourth setting process. In FIG. 16, the calculation unit 13C in the control unit 5C obtains a set amount of attenuation and a set wavelength (Step S91). The set amount of attenuation and the set wavelength are obtained from, for example, the user device 50. The calculation unit 13C obtains a set temperature from the temperature monitor 3 (Step S92).

The setting unit 11C calculates a set amount of attenuation that has been subjected to wavelength correction, by multiplying the set amount of attenuation by a wavelength correction factor (Step S93). By substituting the set amount of attenuation that has been subjected to the wavelength correction into Equation 2, the calculation unit 13C calculates a first driving current value at the standard temperature T2 (Step S94). Furthermore, by substituting the set wavelength into Equation 14, the calculation unit 13C calculates a wavelength correction factor (Step S95).

The calculation unit 13C multiplies the first driving current value at the standard temperature T2 and calculated by Equation 2 by the temperature correction factor calculated by Equation 7 and the wavelength correction factor calculated by Equation 14 and thereby calculates a second driving current value that has been corrected (Step S96).

By substituting the calculated second driving current value that has been corrected into Equation 15, the calculation unit 13C calculates an amount of attenuation that has been corrected (Step S97). By substituting the amount of attenuation that has been corrected and calculated by Equation 15 into Equation 2, the calculation unit 13C calculates a third driving current value at the standard temperature T2 (Step S98).

By substituting the set temperature into Equation 7, the calculation unit 13C calculates a temperature correction factor (Step S99). The calculation unit 13C multiplies the third driving current value at the standard temperature T2 and calculated by Equation 2 by the temperature correction factor calculated by Equation 7 and thereby calculates a fourth driving current value that has been corrected (Step S100). The calculation unit 13C then sets the calculated fourth driving current value that has been corrected on the driving control unit 14 (Step S101) and ends the processing operation illustrated in FIG. 16. The driving control unit 14 then supplies driving current corresponding to the set fourth driving current value, to the VOA 2. As a result, the VOA 2 is able to achieve the set amount of attenuation at the set temperature and set wavelength.

In the control device 1C according to the fourth embodiment, just by use of Equation 2, Equation 7, Equation 14, and Equation 15 being stored in the storage unit 12C, a driving current value for obtaining a set amount of attenuation at a set wavelength and a set temperature is calculated, and the calculated driving current value is set on the driving control unit 14. As a result, as compared to the conventional technique, the driving current value for the set amount of attenuation at the set temperature and set wavelength is able to be calculated with the difference between the set temperature and the standard temperature and the difference between the set wavelength and the standard wavelength both being corrected and the amount of data being reduced, without the need for any complicated arithmetic processing. What is more, the arithmetic processing is able to be simplified with the amount of needed data being reduced and the advance preparation time period being shortened, the advance preparation time period being for calculation of the driving current value for achieving the set amount of attenuation at the VOA 2. That is, the driving current value for obtaining the set amount of attenuation at the set temperature and set wavelength is able to be obtained with the temperature dependence and wavelength dependence being corrected.

Because the FF control method is adopted in the control device 1C, an optical monitor for FB control is not needed downstream from the VOA 2. What is more, because the FF control method is adopted in the control device 1C, the multiple loop problem is also able to be solved.

The case where all of arithmetic processing is executed by use of a set wavelength and a set amount of attenuation that are obtained from the user device 50 has been described as an example with respect to the control device 1C according to the fourth embodiment. However, some of the arithmetic processing may be shared with a user device 50A and an embodiment related to such a modification will hereinafter be described as a fifth embodiment.

### (e) Fifth Embodiment

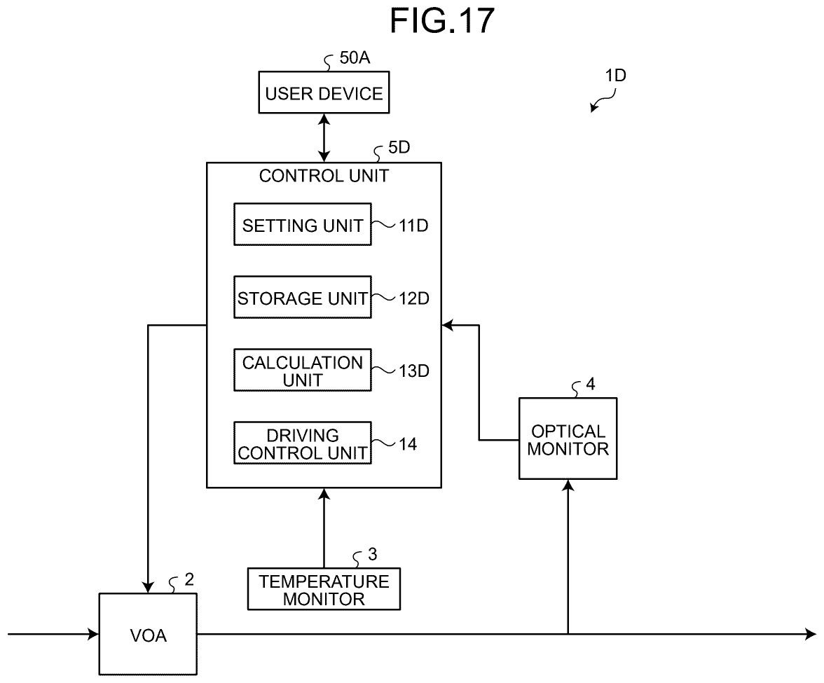

FIG. 17 is a block diagram illustrating an example of a control device 1D according to the fifth embodiment. By assignment of the same reference signs to components that are the same as those of the control device 1C according to the fourth embodiment, any redundant description of the same components and operation thereof will be omitted. The control device 1D according to the fifth embodiment is different from the control device 1C according to the fourth embodiment in that some of arithmetic processing by the control device 1D is shared with the user device 50A.

A control unit 5D of the control device 1D has a setting unit 11D, a storage unit 12D, a calculation unit 13D, and a driving control unit 14. The setting unit 11D calculates Equation 2 and Equation 7 that are based on a set temperature and stores the calculated Equation 2 as a first function and the calculated Equation 7 as a second function, into the storage unit 12D. The setting unit 11D also calculates Equation 14 based on a set wavelength and stores the calculated Equation 14 as a fourth function, into the storage unit 12D. Furthermore, the setting unit 11D stores Equation 15, which has been derived, as a fifth function into the storage unit 12D.

Operation of setting a driving current value for obtaining a set amount of attenuation at a set wavelength and a set temperature by using the first function, the second function, the fourth function, and the fifth function will be described next.

Firstly, the set amount of attenuation is, for example, a desired amount of attenuation set by the user device 50A. The set wavelength is a wavelength of input light set by the user device 50A, for example. The set temperature is, for example, a peripheral temperature around a VOA 2 measured by a temperature monitor 3 regularly or as needed. The user device 50A obtains Equation 2, Equation 14, and Equation 15, from the control unit 5D.

The user device 50A calculates a set amount of attenuation that has been subjected to wavelength correction, by multiplying the set amount of attenuation by a wavelength correction factor. By substituting the set amount of attenuation that has been subjected to the wavelength correction into Equation 2, the user device 50A calculates a first driving current value at a standard temperature T2. Furthermore, by substituting the set wavelength into Equation 14, the user device 50A calculates a wavelength correction factor for correcting a driving current value between the standard wavelength and the set wavelength.

The user device 50A multiplies the first driving current value at the standard temperature T2 and calculated by Equation 2 by the wavelength correction factor calculated by Equation 14 and thereby calculates a second driving current value that has been corrected. By substituting the calculated second driving current value that has been corrected into Equation 15, the user device 50A calculates an amount of attenuation that has been corrected. The user device 50A then notifies the control unit 5D of the calculated amount of attenuation that has been corrected.

Furthermore, by substituting the amount of attenuation that has been corrected into Equation 2, the calculation unit 13D calculates a third driving current value at the standard temperature T2. Furthermore, by substituting the set temperature that is the peripheral temperature into Equation 7, the calculation unit 13D calculates a temperature correction factor for correcting driving current between the standard temperature and the set temperature. The calculation unit 13D then multiplies the calculated third driving current value by the temperature correction factor, thereby calculates a fourth driving current value that has been corrected, and sets the calculated fourth driving current value on the driving control unit 14.

The driving control unit 14 supplies driving current corresponding to the fourth driving current value calculated by the calculation unit 13D, to the VOA 2. As a result, the VOA 2 is able to achieve the set amount of attenuation at the set temperature and set wavelength according to the driving current from the driving control unit 14.

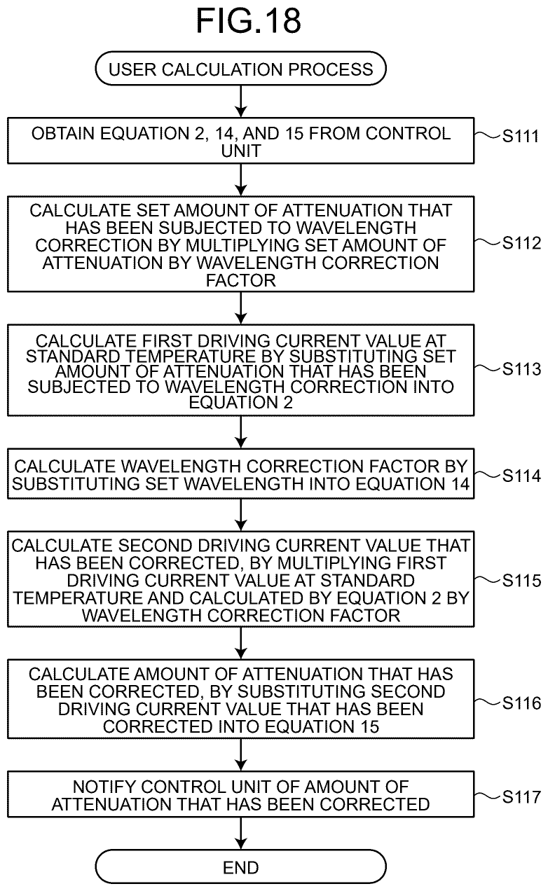

FIG. 18 is a flowchart illustrating an example of processing operation by the user device 50A, the processing operation being related to a user calculation process. In FIG. 18, the user device 50A obtains Equation 2, Equation 14, and Equation 15, from the control unit 5D (Step S111). The user device 50A calculates a set amount of attenuation that has been subjected to wavelength correction, by multiplying a set amount of attenuation by a wavelength correction factor (Step S112).

By substituting the set amount of attenuation that has been subjected to the wavelength correction into Equation 2, the user device 50A calculates a first driving current value at the standard temperature T2 (Step S113). Furthermore, by substituting a set wavelength into Equation 14, the user device 50A calculates a wavelength correction factor (Step S114).

The user device 50A multiplies the first driving current value at the standard temperature T2 and calculated by Equation 2 by the temperature correction factor calculated by Equation 7 and the wavelength correction factor calculated by Equation 14 and thereby calculates a second driving current value that has been corrected (Step S115).

By substituting the calculated second driving current value that has been corrected into Equation 15, the user device 50A calculates an amount of attenuation that has been corrected (Step S116). The user device 50A notifies the control unit 5D of the calculated amount of attenuation that has been corrected (Step S117) and ends the processing operation illustrated in FIG. 18.

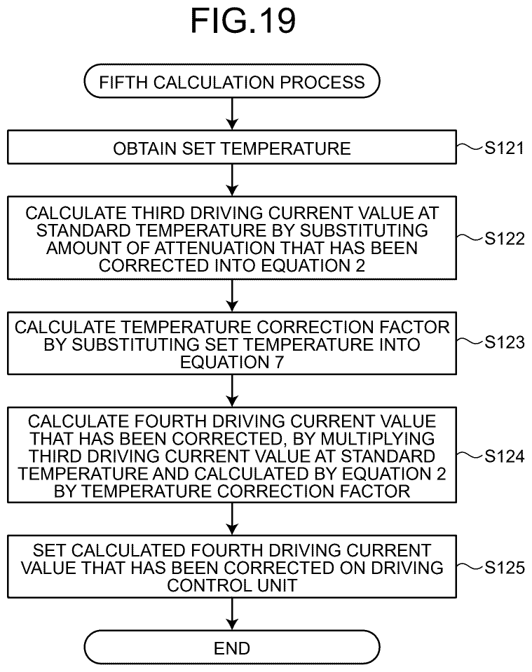

FIG. 19 is a flowchart illustrating an example of processing operation by the control unit 5D, the processing operation being related to a fifth calculation process. In FIG. 19, the calculation unit 13D obtains a set temperature from the temperature monitor 3 (Step S121). By substituting an amount of attenuation that has been corrected and obtained from the user device 50A into Equation 2, the calculation unit 13D calculates a third driving current value at the standard temperature T2 (Step S122).

By substituting the set temperature into Equation 7, the calculation unit 13D calculates a temperature correction factor (Step S123). The calculation unit 13D multiplies the third driving current value at the standard temperature T2 and calculated by Equation 2, by the temperature correction factor calculated by Equation 7, and thereby calculates a fourth driving current value that has been corrected (Step S124). The calculation unit 13D then sets the calculated fourth driving current value that has been corrected on the driving control unit 14 (Step S125) and ends the processing operation illustrated in FIG. 19. The driving control unit 14 then supplies driving current corresponding to the set fourth driving current value, to the VOA 2. As a result, the VOA 2 is able to achieve the set amount of attenuation at the set temperature and set wavelength.

In the control device 1D according to the fifth embodiment, just by use of Equation 2, Equation 7, Equation 14, and Equation 15 being stored in the storage unit 12D, a driving current value for obtaining a set amount of attenuation at a set wavelength and a set temperature is calculated, and the calculated driving current value is set on the driving control unit 14. As a result, as compared to the conventional technique, the driving current value for the set amount of attenuation at the set temperature and set wavelength is able to be calculated with the difference between the set temperature and the standard temperature and the difference between the set wavelength and the standard wavelength both being corrected and the amount of data being reduced, without the need for any complicated arithmetic processing. What is more, the arithmetic processing is able to be simplified with the amount of needed data being reduced and the advance preparation time period being shortened, the advance preparation time period being for calculation of the driving current value for achieving the set amount of attenuation at the VOA 2. That is, the driving current value for obtaining the set amount of attenuation at the set temperature and set wavelength is able to be obtained with the temperature dependence and wavelength dependence being corrected.

The user device 50A executes arithmetic processing for a first driving current value calculated by Equation 2, a wavelength correction factor calculated by Equation 14, a second driving current value calculated by Equation 2, and an amount of attenuation that has been corrected and calculated by Equation 15. As a result, the processing load needed for arithmetic processing by the control device 1D is able to be reduced largely.

Because the FF control method is adopted in the control device 1D, an optical monitor for FB control is not needed downstream from the VOA 2. What is more, because the FF control method is adopted in the control device 1D, the multiple loop problem is also able to be solved.

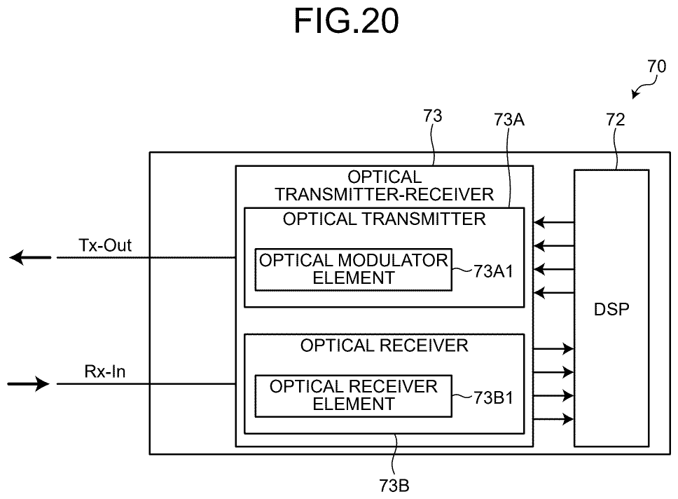

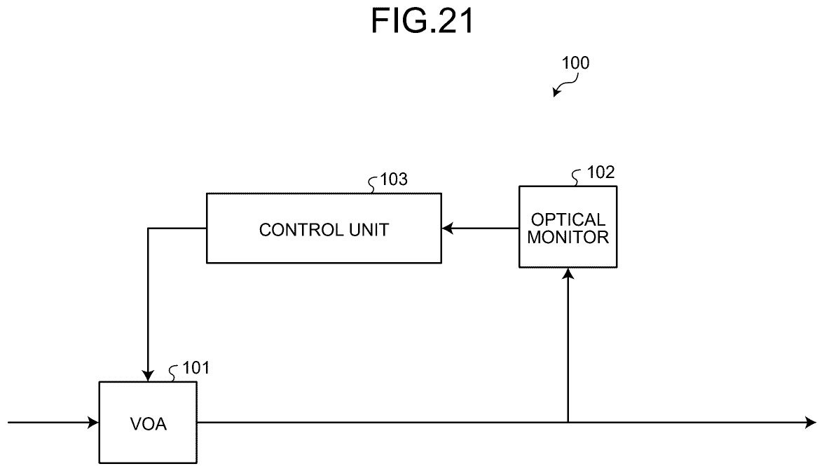

FIG. 20 is a diagram illustrating an example of an optical transceiver 70 according to an embodiment. The optical transceiver 70 illustrated in FIG. 20 is connected to an output optical fiber and an input optical fiber. The optical transceiver 70 has a digital signal processor (DSP) 72 and an optical transmitter-receiver 73. The optical transmitter-receiver 73 has an optical transmitter 73A and an optical receiver 73B. The DSP 72 is an electric component that executes digital signal processing. For example, the DSP 72 executes processing, such as encoding of transmitted data, generates an electric signal including the transmitted data, and outputs the generated electric signal to the optical transmitter 73A. Furthermore, the DSP 72 obtains an electric signal including received data from the optical receiver 73B, and obtains the received data by executing processing, such as decoding of the electric signal obtained.

The optical transmitter 73A has an optical modulator element 73A1 that modulated supplied light by using an electric signal output from the DSP 72, and outputs transmitted light modulated by use of the electric signal, to the optical fiber. The optical modulator element 73A1 has a control device built therein.

The optical receiver 73B has an optical receiver element 73B1 that receives an optical signal from the optical fiber and demodulates received light by using supplied light, converts the demodulated received light into an electric signal, and outputs the converted electric signal to the DSP 72. The optical receiver element 73B1 has a control device built therein.

The control devices in the optical transceiver 70 each have a variable attenuator that attenuates input light, a temperature monitor that measures a peripheral temperature around the variable attenuator, and a control unit that controls the variable attenuator. The control unit has a storage unit, a calculation unit, and a driving control unit. The storage unit stores a first function approximating a relation between amounts of attenuation and driving current values for the variable attenuator at a standard temperature, and a second function for calculating a temperature correction factor that corrects a driving current value between the peripheral temperature and the standard temperature. By substituting a set amount of attenuation into the first function, the calculation unit calculates a driving current value at the standard temperature, and by substituting the current peripheral temperature into the second function, the calculation unit calculates a temperature correction factor at the peripheral temperature. On the basis of the driving current value at the standard temperature and calculated by the first function and the temperature correction factor at the peripheral temperature and calculated by the second function, the calculation unit calculates a driving current value for obtaining the set amount of attenuation at the peripheral temperature. On the basis of the driving current value calculated by the calculation unit, the driving control unit controls driving of the variable attenuator. As a result, the driving current value for the set amount of attenuation at the set temperature is able to be calculated with the difference between the set temperature and the standard temperature being corrected.

For convenience of description, the case where the optical transceiver 70 has the optical transmitter 73A and the optical receiver 73B built therein has been described as an example, but the optical transceiver 70 may have any one of the optical transmitter 73A and the optical receiver 73B built therein. For example, a control device may be applied to an optical transceiver 70 having an optical receiver 73B built therein or any other modification may be made as appropriate.

Furthermore, the components of each unit illustrated in the drawings may be not configured physically as illustrated in the drawings. That is, specific modes of separation and integration of the units are not limited to those illustrated in the drawings, and all or part thereof may be configured to be functionally or physically separated or integrated in any units according to various loads and use situations, for example.

Furthermore, all or any part of the various processing functions performed at each device may be executed on a central processing unit (CPU) (or a microcomputer, such as a microprocessing unit (MPU) or a microcontroller unit (MCU)). Furthermore, all or any part of the various processing functions may of course be executed on a program analyzed and executed by a CPU (or a microcomputer, such as an MPU or MCU) or on hardware by wired logic.

According to an aspect of a control device disclosed by the present application, the processing load for accurately calculating a driving current value for obtaining a set amount of attenuation is able to be reduced.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device, comprising:
a variable attenuator that attenuates input light;
a temperature monitor that measures a peripheral temperature around the variable attenuator; and
a controller that controls the variable attenuator, wherein
the controller includes processing circuitry configured to:
store a first function approximating a relation between amounts of attenuation and driving current values for the variable attenuator at a standard temperature, and a second function for calculating a temperature correction factor that corrects a driving current value between the peripheral temperature and the standard temperature;
calculate, by substituting a set amount of attenuation into the first function, a driving current value at the standard temperature, calculate, by substituting a current peripheral temperature into the second function, a temperature correction factor at the peripheral temperature, and calculate, based on the driving current value at the standard temperature and calculated by the first function and the temperature correction factor at the peripheral temperature and calculated by the second function, a driving current value for obtaining the set amount of attenuation at the peripheral temperature; and
control driving of the variable attenuator based on the driving current value calculated by the calculating.

2. The control device according to claim 1, wherein
the processing circuitry is configured to store a third function approximating a relation between amount of attenuation and driving current values for the variable attenuator at a standard wavelength, and a fourth function for calculating a wavelength correction factor that corrects a driving current value between a set wavelength and the standard wavelength, and
calculate, by substituting the set amount of attenuation into the first function, a driving current value at the standard temperature, calculate, by substituting the current peripheral temperature into the second function, a temperature correction factor at the peripheral temperature, calculate, by substituting the set wavelength into the fourth function, a wavelength correction factor at the set wavelength, and calculate, based on the driving current value at the standard temperature and calculated by the first function, the temperature correction factor at the peripheral temperature and calculated by the second function, and the wavelength correction factor at the set wavelength and calculated by the fourth function, a driving current value for obtaining the set amount of attenuation at the peripheral temperature and the set wavelength.

3. The control device according to claim 1, wherein the processing circuitry is configured to obtain the first function from plural quadratic functions approximating relations between amounts of attenuation and driving current values for the variable attenuator at different reference temperatures.

4. The control device according to claim 3, wherein the obtaining includes averaging coefficients of each order of the plural quadratic functions approximating the relations between the amounts of attenuation and the driving current values for the variable attenuator at the respective reference temperatures, and obtaining, as the second function, a quadratic function using the averaged coefficients.

5. The control device according to claim 2, wherein the processing circuitry is configured to obtain the third function from plural quadratic functions approximating relations between amounts of attenuation and driving current values for the variable attenuator at different reference wavelengths.

6. The control device according to claim 5, wherein the obtaining includes averaging coefficients of each order of the plural quadratic functions approximating the relations between the amounts of attenuation and the driving current values for the variable attenuator at the respective reference wavelengths, and obtaining, as the fourth function, a quadratic function using the averaged coefficients.

7. The control device according to claim 1, wherein the variable attenuator is an electroabsorption variable attenuator that controls an amount of attenuation according to driving current corresponding to the driving current value.

8. The control device according to claim 2, wherein the processing circuitry is configured to:
obtain a fifth function from plural quadratic functions approximating relations between amounts of attenuation and driving current values for the variable attenuator at respective standard temperatures; and
calculate, by substituting the set amount of attenuation into the first function, a driving current value at the standard temperature, calculate, by substituting the current peripheral temperature into the second function, a temperature correction factor at the peripheral temperature, calculate, by substituting the set wavelength into the fourth function, a wavelength correction factor at the set wavelength, calculate, based on the driving current value at the standard temperature and calculated by the first function and the wavelength correction factor at the set wavelength and calculated by the fourth function, a driving current value that has been corrected, calculate, by substituting the calculated driving current value that has been corrected into the fifth function, an amount of attenuation that has been corrected, calculate, by substituting the amount of attenuation that has been corrected into the first function, a driving current value at the standard temperature, and calculate, by multiplying the calculated driving current value at the standard temperature by the temperature correction factor, a driving current value for obtaining the set amount of attenuation at the peripheral temperature and the set wavelength.

9. A control device, comprising:
a variable attenuator that attenuates input light;
a temperature monitor that measures a peripheral temperature around the variable attenuator; and
a controller that controls the variable attenuator, wherein
the controller includes processing circuitry configured to:
store a first function approximating a relation between amounts of attenuation and driving current values for the variable attenuator at a standard wavelength and a second function for calculating a wavelength correction factor that corrects a driving current value between a set wavelength and the standard wavelength;
calculate, by substituting a set amount of attenuation into the first function, a driving current value at the standard wavelength, calculate, by substituting the set wavelength into the second function, a wavelength correction factor at the set wavelength, and calculate, based on the driving current value at the standard wavelength and calculated by the first function and the wavelength correction factor at the set wavelength and calculated by the second function, a driving current value for obtaining the set amount of attenuation at the set wavelength; and
control driving of the variable attenuator based on the driving current value calculated by the calculating.

10. An optical communication equipment, comprising:
an optical element including an optical receiver element that converts received signal light into an electric signal or an optical modulator element that modulates guided light according to an electric signal, wherein
the optical element includes:
a variable attenuator that attenuates input light;
a temperature monitor that measures a peripheral temperature around the variable attenuator; and
a controller that controls the variable attenuator, and
the controller includes processing circuitry configured to:
store a first function approximating a relation between amounts of attenuation and driving current values for the variable attenuator at a standard temperature, and a second function for calculating a temperature correction factor that corrects a driving current value between the peripheral temperature and the standard temperature;
calculate, by substituting a set amount of attenuation into the first function, a driving current value at the standard temperature, calculate, by substituting a current peripheral temperature into the second function, a temperature correction factor at the peripheral temperature, and calculate, based on the driving current value at the standard temperature and calculated by the first function and the temperature correction factor at the peripheral temperature and calculated by the second function, a driving current value for obtaining the set amount of attenuation at the peripheral temperature; and
control driving of the variable attenuator based on the driving current value calculated by the calculating.
